(19) United States
(12) Patent Application Publication
(10) Pub. No.: US 2026/0370290 A1
(43) Pub. Date: Nov. 19, 2026

(54) APPARATUS AND METHODS OF CHANNEL STATE INFORMATION ACQUISITION UNDER MULTIPLE SERVING AND INTERFERENCE HYPOTHESES

(71) Applicant: QUALCOMM Incorporated, San Diego, CA (US)

(72) Inventors: Narayan PRASAD, Westfield, NJ (US); Mohamed Fouad Ahmed Marzban, San Diego, CA (US); Sony Akkarakaran, Poway, CA (US); Wooseok Nam, San Diego, CA (US); Mostafa Khoshnevisan, San Diego, CA (US); Tao Luo, San Diego, CA (US); Qian Zhang, Basking Ridge, NJ (US); Wenjun Li, Basking Ridge, NJ (US)

(21) Appl. No.: 19/666,083

(22) Filed: May 1, 2026

Related U.S. Application Data
(60) Provisional application No. 63/806,551, filed on May 15, 2025.

(51) Int. Cl. H04B 7/06

(52) U.S. Cl. CPC H04B 7/0626; H04B 7/0639

(57) ABSTRACT

Example implementations include a method, apparatus and computer-readable medium of wireless communication for measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The implementations further include transmitting one or more CSI reports for the one or more sub-configurations based on the measuring of the one or more channels performed according to the common CSI configuration. Additional implementations include a corresponding method, apparatus and computer-readable medium of wireless communication for transmitting the common CSI configuration, and receiving the respective CSI reports.

### CROSS-REFERENCE TO RELATED APPLICATIONS

This application claims the benefit of U.S. Provisional Application No. 63/806,551, filed on May 15, 2025 and entitled “APPARATUS AND METHODS OF CHANNEL STATE INFORMATION ACQUISITION UNDER MULTIPLE SERVING AND INTERFENCE HYPOTHESES,” the contents of which are incorporated by reference herein in the entirety.

### FIELD

The present disclosure relates to wireless communication, and more specifically, to channel estimation and reporting of channel state information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

An aspect of the various telecommunication standards relates to channel state information (CSI) reporting, where a user equipment (UE) sends a CSI report to a network device. The CSI report includes information that describes the properties of a radio communication channel, which are used by the network device for radio resource management. To meet the ever-growing demand in the use of wireless networks, improvements in CSI reporting are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The systems, methods and devices of this disclosure each have several innovative aspects, no single one of which is solely responsible for the desirable attributes disclosed herein.

An example aspect includes a method of wireless communication, comprising measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The method further includes transmitting one or more CSI reports for the one or more sub-configurations based on the measuring of the one or more channels performed according to the common CSI configuration.

Another example aspect includes an apparatus for wireless communication, comprising one or more memories and one or more processors coupled with the one or more memories and configured to perform, individually or in any combination, the following actions. The one or more processors are configured to measure one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The one or more processors are further configured to transmit one or more CSI reports for the one or more sub-configurations based on the measuring of the one or more channels performed according to the common CSI configuration.

Another example aspect includes an apparatus for wireless communication, comprising means for measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The apparatus further includes means for transmitting one or more CSI reports for the one or more sub-configurations based on the measuring of the one or more channels performed according to the common CSI configuration.

Another example aspect includes a computer-readable medium (or a non-transitory computer-readable medium) comprising stored instructions for wireless communication, wherein the instructions are executable by one or more processors, individually or in any combination, to perform the following actions. The instructions are executable to measure one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The instructions are further executable to transmit one or more CSI reports for the one or more sub-configurations based on the measuring of the one or more channels performed according to the common CSI configuration.

An example aspect includes a method of wireless communication, comprising transmitting a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The method further includes receiving one or more CSI reports for one or more channels defined by the one or more sub-configurations based on measurements of the one or more channels performed according to the common CSI configuration.

Another example aspect includes an apparatus for wireless communication, comprising one or more memories and one or more processors coupled with the one or more memories and configured to perform, individually or in any combination, the following actions. The one or more processors are configured to transmit a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The one or more processors are further configured to receive one or more CSI reports for one or more channels defined by the one or more sub-configurations based on measurements of the one or more channels performed according to the common CSI configuration.

Another example aspect includes an apparatus for wireless communication, comprising means for transmitting a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The apparatus further includes means for receiving one or more CSI reports for one or more channels defined by the one or more sub-configurations based on measurements of the one or more channels performed according to the common CSI configuration.

Another example aspect includes a computer-readable medium (or a non-transitory computer-readable medium) comprising stored instructions for wireless communication, wherein the instructions are executable by one or more processors, individually or in any combination, to perform the following actions. The instructions are to transmit a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. The instructions are further executable to receive one or more CSI reports for one or more channels defined by the one or more sub-configurations based on measurements of the one or more channels performed according to the common CSI configuration.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a diagram illustrating an example of a wireless communications network including a base station providing a user equipment (UE) with a common channel state information (CSI) configuration for performing multi-hypothesis channel estimation and reporting, in accordance with one or more aspects of this disclosure.

FIG. 2A is a diagram illustrating an example of a first frame that may be used for communications in the wireless communications network of FIG. 1, in accordance with one or more aspects of this disclosure.

FIG. 2B is a diagram illustrating an example of downlink (DL) channels within a subframe that may be used for communications in the wireless communications network of FIG. 1, in accordance with one or more aspects of this disclosure.

FIG. 2C is a diagram illustrating an example of a second frame that may be used for communications in the wireless communications network of FIG. 1, in accordance with one or more aspects of this disclosure.

FIG. 2D is a diagram illustrating an example of a subframe that may be used for communications in the wireless communications network of FIG. 1, in accordance with one or more aspects of this disclosure.

FIG. 3 is a diagram illustrating an example of components of a base station (BS) and user equipment (UE) in wireless communication network, such as the wireless communications network of FIG. 1, in accordance with one or more aspects of this disclosure.

FIG. 4 is a diagram illustrating an example disaggregated base station architecture in a wireless network, which may be utilized in an alternative architecture of the wireless communications network of FIG. 1, in accordance with one or more aspects of this disclosure.

FIG. 5 is a block diagram of an example of a structure of the common CSI configuration of FIG. 1, in accordance with one or more aspects of this disclosure.

FIG. 6 is a schematic diagram of an example of channel state information reference signal (CSI-RS) resources in the form of two transmission reception points (TRPs) and corresponding subsets of ports that may be indicated as serving and interference hypotheses in one or more sub-configurations of the common CSI configuration described herein.

FIG. 7 is a schematic diagram of representations of a plurality of different example tuples that may be indicated in one or more sub-configurations of the common CSI configuration described herein.

FIG. 8 is a block diagram of an example of a structure of a multi-hypotheses CSI report based on an indicated subset of the one or more sub-configurations of the common CSI configuration described herein.

FIG. 9 is a schematic diagram of an example of master serving and interference sets that may be utilized with the common CSI configuration described herein.

FIG. 10 is a messaging diagram of an example message flow according to one or more aspects described herein.

FIG. 11 is a block diagram of an example of a UE having components configured to perform a method of wireless communication as described herein.

FIG. 12 is a flowchart of an example of a method of wireless communication as described herein.

FIGS. 13-20 are flowcharts of additional aspects of the method of FIG. 12.

FIG. 21 is a block diagram of an example of a base station having components configured to perform a method of wireless communication as described herein.

FIG. 22 is a flowchart of an example of a method of wireless communication as described herein.

FIGS. 23-28 are flowcharts of additional aspects of the method of FIG. 22.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure relate to improvements in multi-hypotheses channel state information (CSI) configuration, acquisition and reporting. CSI refers to the information that describes the properties of a radio communication channel, such as quality, fading, interference, and other characteristics of the channel. In this context, the channel refers to a radio propagation channel between a receiver (e.g., a user equipment (UE) or a base station (BS) or other network device) and a transmitter (e.g., an opposite one of the UE, BS, or network device), which may be affected by interference from other transmitters (e.g., other UEs, BSs, or network devices). The transmitter in this case may be referred to herein as a channel state information reference signal (CSI-RS) resource, as the transmitter is configured to transmit one or more reference signals (RSs), e.g., signals having known characteristics, to the receiver for use in measuring and reporting the channel state information (CSI) for the channel. In the case where the transmitter is a base station and the receiver is a UE, the channel may be referred to as a downlink channel, and the CSI as downlink CSI. As such, in the CSI context, the channel may be associated with a set of transmitting or serving resources associated with the device the receiver intends to communicate with, and a set of interfering resources associated with other transmitting devices, including other known transmitting devices and/or other unknown transmitting devices. For example, in the case of a UE attempting to measure a channel with a serving BS, these resources may include channel measurement indicator (CMI) resources and interference measurement resources (IMR). CMI resources are a set of time and frequency resources configured to enable the UE to measure a reference signal transmitted by the serving cell, while IMR resources are a set of time and frequency resources configured to allow the UE to measure interference from neighboring cells, beams, or other sources. The measured combination of the CMI and IMR resources, along with other configured parameters, may be referred to as a hypothesis.

In advanced wireless communication technologies, such as 5G NR and/or 6G, the transmitting device may be referred to as a transmission reception point (TRP), which includes an antenna array. The antenna array includes a plurality of logical and/or physical ports for transmitting and/or receiving signals, and different subsets of ports may transmit and/or receive simultaneously. As such, different subsets of ports may be associated with different CMI resources and/or IMR resources.

In order to obtain the CSI, the receiver estimates the channel based on reference signals sent by the transmitter for a set of CMI resources and IMR resources. In multi-hypothesis CSI estimation and reporting, instead of a single channel estimate, the multi-hypothesis approach processes several possible channel estimates (hypotheses) simultaneously. In one or more aspects, a multi-hypothesis CSI procedure, such as described herein, includes a plurality of serving hypotheses and a corresponding plurality of interference hypotheses and/or outside interference indictors. Accordingly, in one or more aspects, a serving hypothesis refers to a specific set of assumptions or configurations regarding the transmission parameters that are considered by the network and UE when measuring, reporting, or predicting CSI of a transmitting device that is serving the UE, e.g., a serving base station and/or a serving TRP. For instance, in an aspect, the serving hypothesis may include a CSI-RS resource identifier that identifies a transmitting device that is serving the UE, such as but not limited to a specific base station and/or a specific TRP. Correspondingly, in one or more aspects, an interference hypothesis refers to a specific set of assumptions or configurations regarding the transmission parameters that are considered by the network and UE when measuring, reporting, or predicting CSI of a transmitting device that is interfering with signals transmitted by the device serving the UE, e.g., an interfering base station and/or an interfering TRP. For instance, in an aspect, the interference hypothesis may include a CSI-RS resource identifier that identifies a transmitting device that is interfering with the UE, such as but not limited to a specific base station and/or a specific TRP that is within a measurement set of the UE. In this case, a measurement set of the UE refers to a specific group or collection of transmission resources, such as antenna ports, beams, or TRPs, that the UE is instructed or configured to monitor, measure, and report on as part of its CSI or other radio measurement procedures. Additionally, for example, both the serving hypothesis and the interference hypothesis may include an identification of a subset of ports that are used to transmit the signals, and/or a power level and/or power offset, which refers to a specified adjustment or difference in transmission power level that is applied to one or more transmission resources, such as antenna ports, beams, or transmission and reception points (TRPs), relative to a reference power level. Alternatively, or in what may be considered a special case of an interference hypothesis, instead of being paired with one or more interference hypothesis, a respective serving hypothesis may be paired with an outside interference indicator, which may be utilized in place of the interference hypothesis, such as when a serving hypothesis is to be measured without an interference hypothesis from a CSI-RS resource in the measurement set, wherein the outside interference indicator identifies interference from other transmitting devices (e.g., outside the measurement set) to be taken into account during the CSI measurements.

The receiver then sends the CSI based on the measurements in a CSI report to a requesting device, e.g., a UE sends the CSI report to a serving BS or other network device, to provide information that describes the properties of a radio communication channel for the one or more hypotheses. The serving BS or other network device uses the CSI information for radio resource management.

Existing solutions for implementing multi-hypotheses CSI acquisition and reporting are inefficient and limited to providing a current state of a channel. In the existing approaches for obtaining CSI under different serving and interference hypotheses, for example, using two TRPs, the network configures channel measurement resources (CMR) for the serving TRP and interference measurement resources (IMR) for the interfering TRP. The approach is not scalable or proactive, as each change in serving or interfering subsets or power levels requires reconfiguration, which involves using resources to generate, transmit/receive, and process and setup new configurations. Further, existing approaches are limited to the one-to-one mapping between CMR and IMR. Moreover, existing approaches have limitation(s) imposed by channel coherence time, which refers to the time duration over which the characteristics of the radio channel remain relatively constant. In other words, it is the time interval during which the channel can be considered “static” or “unchanged” from the perspective of the transmitted signal.

In contrast to existing approaches, the present disclosure provides a comprehensive framework for efficient CSI acquisition in scenarios involving multiple serving and interference hypotheses associated with multiple combinations of CSI-RS resources. As compared to the prior approaches, which are not scalable due to the need for frequent reconfiguration of measurement resources with every change in serving or interfering subsets or power levels, the proposed solution provides enhancements to CSI configuration, measurement, and reporting by defining a common CSI configuration with multiple sub-configurations and/or tuples, each representing a combination of serving and interference hypotheses or outside interference indicators, including associated subsets of ports and power offsets associated with each configured CSI-RS resource. For example, this common CSI configuration with multiple sub-configurations and/or tuples reduces network overhead by enabling the UE to receive a single configuration message with a plurality of potential serving and interference hypotheses, along with one or more indications of which portions of the multiple sub-configurations and/or tuples to use for CSI reporting, and when and how to make such measurements and reports. Additionally, the multiple sub-configurations and/or tuples can define current or future hypotheses. Thus, the present disclosure includes a framework that supports dynamic and flexible CSI reporting based on the common CSI configuration, enabling the network to obtain current or predicted future CSI for various hypotheses efficiently.

In further aspects, the present disclosure introduces mechanisms for the network to configure the UE to report CSI for multiple sub-configurations in a single report, to dynamically change the multiple sub-configurations for reporting without any reconfiguration, to utilize prediction capabilities for reporting future CSI information, and to provide confidence measures for predicted channels. The disclosure also defines new UE capabilities, such as resource and computational utilization and prioritization rules, and reporting timelines based on the prediction capabilities of the UE. Additionally, the present disclosure provides methods to validate and adjust prediction accuracy through intermittent checks, ensuring robust results.

In summary, the present disclosure defines a highly scalable, flexible, and efficient framework for obtaining current and future CSI reports under multiple serving and interference hypotheses. The present disclosure enables one or more of advanced prediction, joint reporting, dynamic adaptation to UE capabilities, efficient resource management, and proactive network operation, each of which addresses one or more deficiencies of existing approaches, and each of which provides a significant technical advantage for next-generation wireless networks.

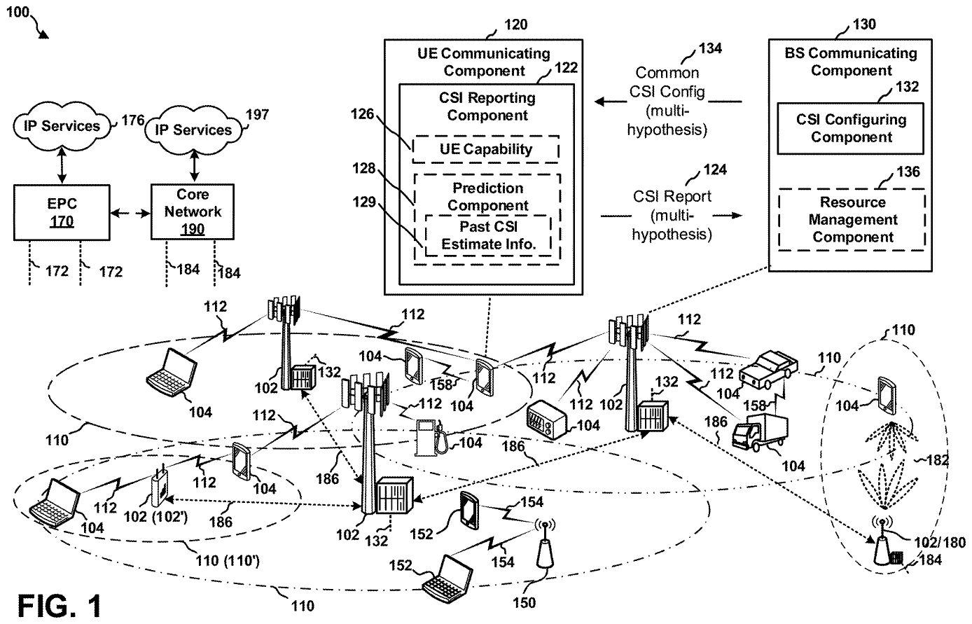

FIG. 1 is a diagram illustrating an example of a wireless communications network 100 in which some nodes, such as one or more UEs 104, include a UE communicating component 120 for communicating with one or more base stations 102 and/or one or more other UEs 104, etc., in wireless communications, in accordance with aspects described herein. In addition, some nodes of the wireless communications network 100, such as one or more base stations 102, include a base station (BS) communicating component 130 for communicating with one or more UEs 104 and/or one or more other base stations 102, in accordance with aspects described herein. Additionally, the BS communicating component 130 includes a channel state information (CSI) configuring component 132 for configuring the UE 104 with a common CSI configuration 134, which defines a multi-hypotheses CSI framework from which subsets of hypotheses may be indicated for CSI reporting. Correspondingly, the UE 104 includes a CSI reporting component 122 configured to receive and execute the indicated subsets of hypotheses from the common CSI configuration 134, and transmit a CSI report 124, including the CSI for the indicated subsets of hypotheses, back to the base station 102. The subset of hypotheses may relate to current hypotheses, future hypotheses, or a combination thereof. For instance, when the UE 104 reports a UE capability 126 that indicates sufficient processing resources and one or more prediction resources, such as a prediction component 128 including resources/models/algorithms and past CSI estimate information 129 (e.g., data relating to previous CSI measurements and estimations), the BS communicating component 130 may include in the common CSI configuration 134 one or more future hypotheses for the UE 104 to predict and report. Additionally, the base station 102 may include a resource management component 136 for configuring the reporting UE 104 and/or other UEs 104 in the wireless network 100 for communications based on information in the CSI report 124. Further details of the above-described aspects are described later herein with reference to various examples.

The wireless communication network 100 (also referred to as a wireless wide area network (WWAN)) includes base stations 102, UEs 104, an Evolved Packet Core (EPC) 170, and another core network 190 (such as a 6G Core (6GVC) and/or a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

The base stations 102 configured for 4G LTE (collectively referred to as Evolved Universal Mobile Telecommunications System (UMTS) Terrestrial Radio Access Network (E-UTRAN)) may interface with the EPC 170 through one or more first backhaul links 172 (such as S1 interface), which may be wired or wireless. The base stations 102 configured for 6G and/or 5G NR (collectively referred to as Next Generation RAN (NG-RAN)) may interface with core network 190 through one or more second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 170 or core network 190) with each other over third backhaul links 186 (such as X2 interface). The third backhaul links 186 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25GHz-52.6 GHz). The frequencies between FR1 and FR2 are often referred to as mid-band frequencies. Although a portion of FR 1 is greater than 6 GHz, FR 1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 170 may include a Mobility Management Entity (MME), other MMEs, a Serving Gateway, a Multimedia Broadcast Multicast Service (MBMS) Gateway, a Broadcast Multicast Service Center (BM-SC), and a Packet Data Network (PDN) Gateway. The MME may be in communication with a Home Subscriber Server (HSS) 174. The MME is the control node that processes the signaling between the UEs 104 and the EPC 170. Generally, the MME provides bearer and connection management. All user Internet protocol (IP) packets are transferred through the Serving Gateway, which itself is connected to the PDN Gateway. The PDN Gateway provides UE IP address allocation as well as other functions. The PDN Gateway and the BM-SC are connected to the IP Services 176. The IP Services 176 may include the Internet, an intranet, an IP Multimedia Subsystem (IMS), a PS Streaming Service, or other IP services. The BM-SC may provide functions for MBMS user service provisioning and delivery. The BM-SC may serve as an entry point for content provider MBMS transmission, may be used to authorize and initiate MBMS Bearer Services within a public land mobile network (PLMN), and may be used to schedule MBMS transmissions. The MBMS Gateway may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF), other AMFs, a Session Management Function (SMF), and a User Plane Function (UPF). The AMF may be in communication with a Unified Data Management (UDM). The AMF is the control node that processes the signaling between the UEs 104 and the core network 190. Generally, the AMF provides QoS flow and session management. All user Internet protocol (IP) packets are transferred through the UPF. The UPF provides UE IP address allocation as well as other functions. The UPF is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 170 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G systems, the concepts described herein may be applicable to other similar areas, such as 5G NR, LTE, LTE-A, CDMA, GSM, and other future wireless technologies.

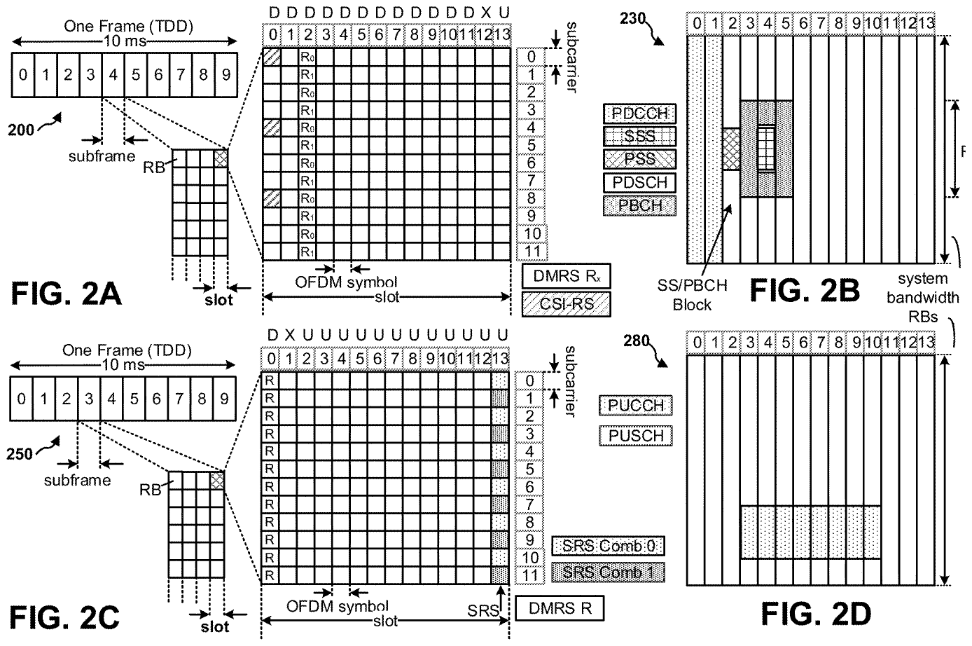

Referring to FIG. 2A-2D, example of frames and frame structures may be used by any of the devices in FIG. 1 and other figures herein for communication. FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

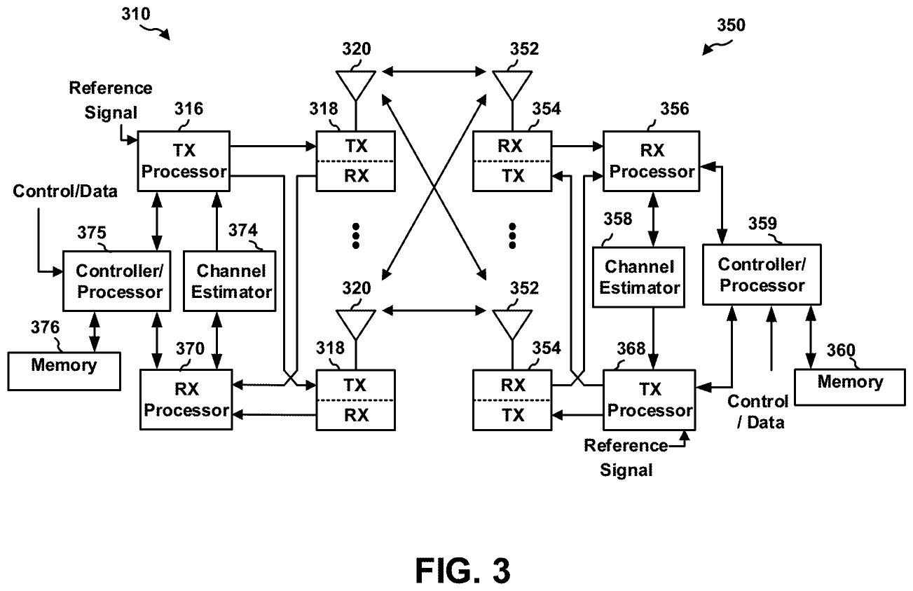

FIG. 3 is a diagram of an example of a base station 310 and a UE 350 in a communication network, such as wireless communication network 100, configured to communicate via network protocols and perform the functions described herein with respect to the UE communicating component 120 and the BS communicating component 130, respectively, of FIG. 1 and as described elsewhere herein. In an aspect, base station 310 may be the same as or similar to base station 102 of FIG. 1, and UE 350 may be the same as or similar to the UE 104 of FIG. 1. In the DL, IP packets from the EPC 170 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 170. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 170. The controller/processor 375 is also responsible for error detection using an ACK or NACK protocol to support HARQ operations.

With respect to UE 350, at least one of the TX processor 368, the RX processor 356, and the controller/processor 359 may be configured to perform aspects in connection with the UE communicating component 120 of FIG. 1. For example, the memory 360 may include executable instructions defining the UE communicating component 120. The TX processor 368, the RX processor 356, and/or the controller/processor 359 may be configured to execute the UE communicating component 120.

With respect to base station 310, at least one of the TX processor 316, the RX processor 370, and the controller/processor 375 may be configured to perform aspects in connection with the BS communicating component 130 of FIG. 1. For example, the memory 376 may include executable instructions defining the BS communicating component 130. The TX processor 316, the RX processor 370, and/or the controller/processor 375 may be configured to execute the BS communicating component 130.

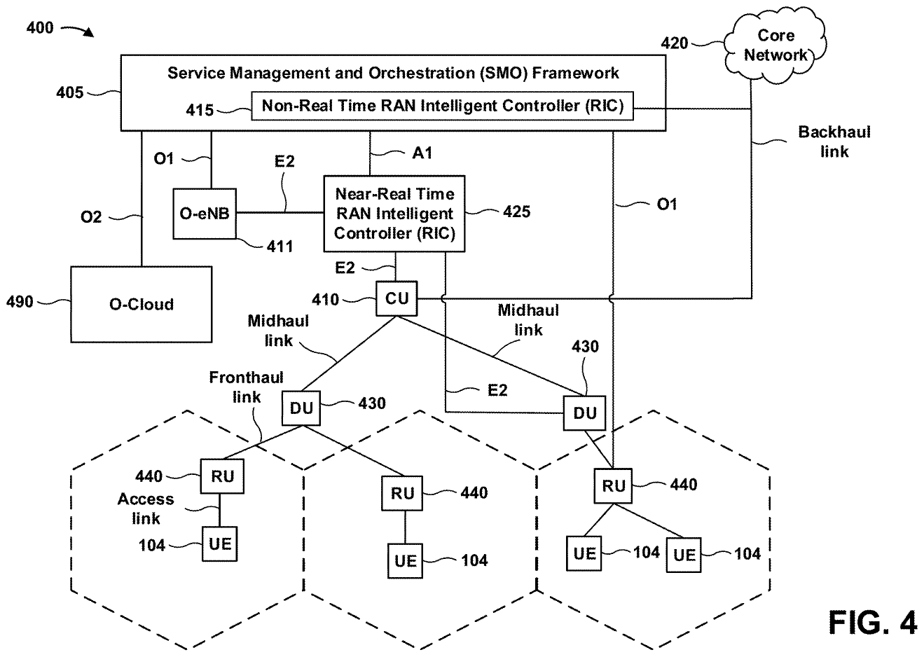

FIG. 4 is a diagram illustrating an example disaggregated base station 400 architecture, which may be one example implementation of the base stations 102 and 310 of FIGS. 1 and 3, respectively, and/or portions of the wireless communication network 100. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

With respect to multi-hypotheses CSI configuration and reporting, as discussed above, there are many inefficiencies and lack of scalability in existing approaches used in wireless networks, such as in 5G NR, where multiple re-configuration messages are used to configure a UE to use different channel measurement and interference measurement resources to compute CSI under different interference hypotheses.

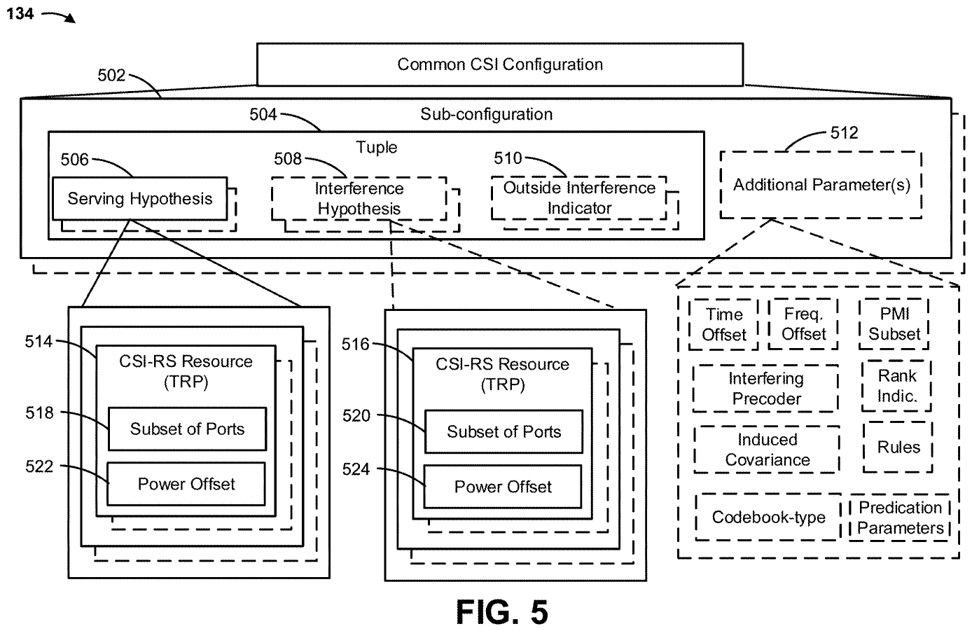

Referring to FIGS. 5-10, the apparatus and methods of the present disclosure utilize the common CSI configuration 134 (FIG. 5) as part of an improved CSI reporting framework, which can also take advantage of a prediction capability of the UE 104, to efficiently obtain current and future CSI reports 124 associated with multiple serving and interference hypotheses. As such, the aspects address one or more drawbacks of existing approaches.

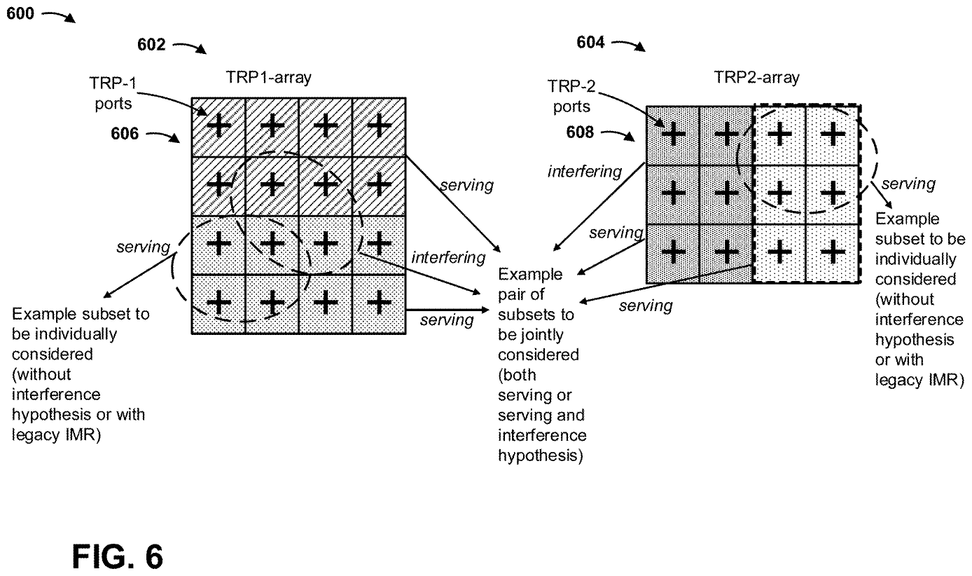

According to the present disclosure, in a multi-hypothesis scenario 600 (FIG. 6) associated with two transmitting devices or CSI-RS resources, such as TRP-1 602 and TRP-2 604 in this case, the network (e.g., base station 102 and/or another network device such as in the EPC 170 or core network 190) configures a CSI-RS resource configuration for each TRP, where the CSI-RS resource configuration is used to identify the CSI-RS resource and indicate serving or interference parameters, as described herein. For example, the network can configure CSI-RS resource configuration 514 (FIG. 5) for TRP-1 602 (e.g., in an example of common CSI configuration 134 where TRP-1 602 is used in a serving hypothesis) and CSI-RS resource configuration 516 (FIG. 5) for TRP-2 604 (e.g., in an example where TRP-2 604 is used in an interference hypothesis). As noted above, a serving hypothesis refers to a specific set of assumptions or configurations regarding the transmission parameters that are considered by the network and UE when measuring, reporting, or predicting CSI of a transmitting device that is serving the UE, and an interference hypothesis is similar but for an interfering device. Accordingly, in this case, one example of sub-configuration 502 (FIG. 5) includes an example serving hypothesis 506 configured to identify TRP-1 602 as the serving device that transmits signals that the UE 104 desires to receive, e.g., from the configured subset of ports 518 and power offset 522, and an example interference hypothesis 508 configured to identify TRP-1 604 as the interfering device that transmits signals that interfere with the receipt by the UE 104 of the signal from the serving device, where the transmitted interfering signals are associated with the configured subset of ports 520 and power offset 524. It should be noted that each TRP out of a group of TRPs in a measurement set of the UE 104 is configured with a respective CSI resource configuration. The TRPs in the measurement set of the UE 104 may be defined by the network and/or may be based on received signal strength measurements by the UE 104. In any case, the network then configures the single, common CSI configuration 134 that links or ties to both these CSI-RS resource configurations 514 and 516 for use in CSI measurement and reporting.

In particular, the common CSI configuration 134 has one or more sub-configurations 502 (as indicated by the dashed lines), where each sub-configuration 502 includes a tuple 504 that indicates one or more serving hypothesis 506 and one or more interference hypothesis 508 or an outside interference indicator 510, as described herein. As described herein, in one or more aspects, a tuple indicates or represents a combination of a serving hypothesis and one or more interference hypotheses or outside interference indicators, wherein the serving and interference hypotheses include associated subsets of ports and power offsets associated with each configured CSI-RS resource. Each serving hypothesis 506 and each interference hypothesis 508 respectively comprises a subset of ports 518 and 520 and power-offsets 522 and 524 for a corresponding one or more serving CSI-RS resource configurations (e.g., TRPs), such as CSI-RS resource configurations 514 and 516 in this example, with no overlap among subsets of ports 518, 520 of the serving hypothesis 506 and interference hypothesis 508 of the tuple 504. As such, each sub-configuration 502 is used by the base station 102 or network to obtain the CSI report 124 from the UE 104 under the serving hypothesis 506 of being served by subsets of ports 518 of one or more CSI-RS resources (e.g., TRP-1 602 in this example) in the measurement set. In a special case, the serving hypothesis 506 and the interference hypothesis 508 can be different, non-overlapping subsets of ports 518, 520 of a single serving CSI-RS resource (e.g., a single TRP). Additionally, each sub-configuration 502 can also include the interference hypothesis 508 that is formed by subsets of ports 520 from one or more interference TRPs (e.g., TRP-2 604 in this example) in the measurement set, with no overlap among the subsets of ports 518 and 520 in the serving set and the interfering set. Further, the outside interference indicator 510 may be utilized in place of the interference hypothesis 508, such as when a serving hypothesis is to be measured without an interference hypothesis from a CSI-RS resource in the measurement set, and to take into account interference from other transmitting devices (e.g., outside the measurement set). As such, the outside interference indicator 510 can be associated with channel state information-interference measurement (CSI-IM) resources, which can be used for interference outside the measurement set. For instance, CSI-IM may be special reference signals (or muted resource elements) that allow the UE to measure interference and noise levels, independent of the desired signal.

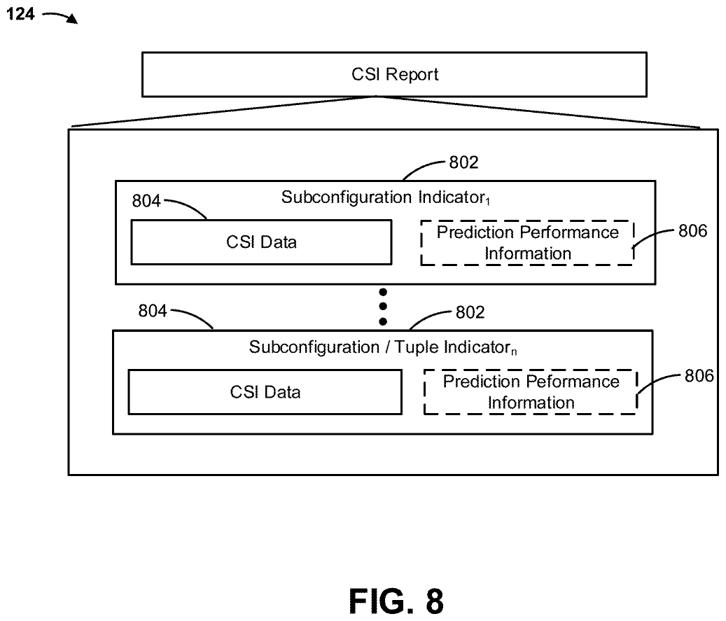

Referring to FIG. 8, additionally, the CSI report 124 of the CSI data 804 of multiple respective sub-configurations 502, e.g. 1 to n where n is a whole number, as indicated by the sub-configuration indicator 802 in the CSI report 124, is obtained from the UE 104. In some cases, the content and/or timing and CSI data 804 of the CSI report 124 may be directed according to one or more configured additional parameters 512 for the respective sub-configuration 502. For instance, suitable examples of the one or more additional parameters 512 include, but are not limited to parameters such as CSI-report type (codebook type and subset), rank indicator (RI), wideband or sub-band precoding matrix indicators (PMIs) or channel quality indicators (CQIs).

For instance, in one example that should not be construed as limiting, the codebook type may determine the set and structure of possible precoding matrices, affecting CSI measurement granularity. The PMI subset may restrict the set of precoding matrices the UE considers, impacting measurement complexity and potential performance. The rank indicator may indicate the number of spatial layers (streams). The rank indicator may reflect the number of independent data streams that the channel can support, given current conditions, influencing how the UE measures the channel and selects precoders. For example, a higher rank indicator may mean the UE will look for precoders that support more spatial streams, which can increase throughput if the channel supports it. However, if the channel conditions are poor, a lower rank may be optimal to avoid interference between streams. Wideband PMI/CQI values may represent the UE's assessment of the channel averaged over the entire configured bandwidth. Wideband PMI may indicate the preferred precoding matrix for the whole band, while wideband CQI may reflect the overall channel quality, guiding the selection of a suitable modulation and coding scheme (MCS) for the entire bandwidth. Sub-band PMI/CQI values may provide more granular information, with the UE reporting preferred precoding matrices (PMI) and channel quality (CQI) for specific frequency sub-bands within the total bandwidth. This allows the network to adapt transmission parameters on a per-sub-band basis, which is especially beneficial in frequency-selective fading environments. Together or in any combination, these parameters shape how CSI is measured, reported, and used for downlink transmission in wireless communication networks, balancing feedback overhead with achievable performance. As such, the network can control the performance tradeoffs, as a more detailed parameters can improve performance but increase feedback overhead.

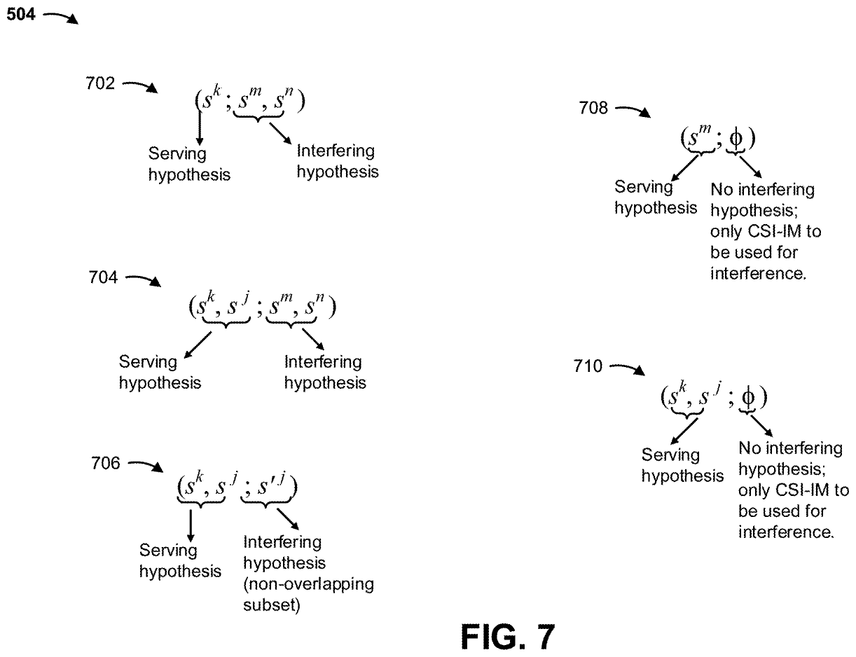

Referring to FIG. 7, various examples of representations of tuples 504 that may be used in a respective sub-configuration 502 are provided to further illustrate the principles described herein of the enhanced CSI acquisition and reporting framework for multi-CSI-RS resource hypotheses configurations using the common CSI configuration 134. In these examples, “s” indicates respective hypothesis, and one or more serving hypotheses 506 are indicated to a left of a semi-colon within the tuple, and one or more interference hypotheses 508 or an outside interference indicator 510 (represented by φ) are positioned to a right of the semi-colon in the tuple.

For instance, tuple 702 represented as (s^{k}; s^{m}, sⁿ) indicates use of a kth serving hypothesis with two different interference hypotheses, an mth interference hypothesis and an nth interference hypothesis. Tuple 704 represented as (s^{k}, s^{j}; s^{m}, sⁿ) indicates use of a second, jth serving hypothesis with the two different interference hypotheses relative to tuple 702. Tuple 706 represented as (s^{k}, s^{j}; s'^{j}) indicates use of the kth and jth serving hypotheses with a non-overlapping subset of ports from the same jth CSI-RS resource for the interference hypothesis. Tuple 708 represented as (s^{m}; φ) indicates use of the mth serving hypothesis with no interference hypothesis, but instead using a CSI-IM resource for interference. Similarly, tuple 710 represented as (s^{k}, s^{j}; φ) indicates use of the kth and jth serving hypotheses with no interference hypothesis, but instead using a CSI-IM resource for interference. As such, each tuple specifies CSI-RS resources and associated subsets of ports and associated power-offsets, facilitating efficiently indicating the serving hypothesis 506 and the interference hypotheses within the common CSI configuration 134 that should be used for generating the single multi-hypothesis CSI report 124.

Referring back to FIG. 6, for example, the differently shaded areas represent different example subsets of the plurality of ports 606 and 608 of TRP-1 602 and TRP-2 604, respectively. Similarly, additional example subsets of the plurality of ports 606 and 608 of TRP-1 602 and TRP-2 604, respectively, are identified by the dashed line ovals. These are examples of the subset of ports 518 and 520 that can be respectively identified for different serving hypotheses 506 and different interference hypotheses 508 and/or in different tuples 504 and/or sub-configurations 502 of the common CSI configuration 134, such as using the notation of FIG. 7.

Referring back to FIG. 5, to further expand on the above explanation of the common CSI configuration 134, in one alternative or additional example implementation, each sub-configuration 502 or tuple 504 can be indicated using variable-length indication. For example, the CSI-RS resources (e.g., TRPs) in the sub-configuration 502 can be listed in order, which can be an implicit order, of CSI-RS resource (e.g., TRPs) indices. Further, a special value can be used to indicate that no subset of ports that CSI-RS resource (e.g., TRPs) is present in the sub-configuration 502 or tuple 504, and other values can be used to indicate the subset of CSI-RS resources selected and whether it is for serving or interference hypothesis.

In another alternative or additional implementation, the UE 104 is provided with CSI-RS resource configurations of all CSI-RS resources (e.g., TRPs) in its group or measurement set, such as resource element (RE) positions, associated identifiers (IDs) or spreading codes, quasi-co-location (QCL) information, etc., and the outside interference indicator 510, e.g., an interference measurement resource (IMR) or CSI-IM resource for measuring interference from CSI-RS resources (e.g., TRPs) outside the measurement set.

In yet a further alternative or additional implementation, the sub-configuration 502 can have multiple serving CSI-RS resources (e.g., TRPs) as its serving hypothesis 506, with each serving CSI-RS resource (e.g., TRPs) having an indicated subset of ports 518. In some cases, the UE 104 can be configured to assume that serving CSI-RS resources jointly transmit signals to the UE 104 using respective port subsets as per a multi-TRP (or mTRP) scheme, for example, as per a non-coherent (e.g., not phase aligned) joint transmission (JT) scheme.

Additionally, in other alternative or additional implementation, the sub-configuration 502 can include the same CSI-RS resource (e.g., TRP) in its serving hypothesis 506 and interference hypothesis 508, albeit with different subsets of ports 518 and 520. This type of scenario corresponds to that CSI-RS resource (e.g., associated TRP) performing multi-user multiple input multiple output (MU-MIMO) communications.

Further, in another alternative or additional implementation, for the same serving (or channel) hypothesis 506, there can be multiple different interference hypotheses 508 across different sub-configurations 502. This is different from the existing CSI framework, where only a one-to-one association between serving hypothesis 506 and interference hypothesis 508 (e.g., CMR and IMR) is assumed.

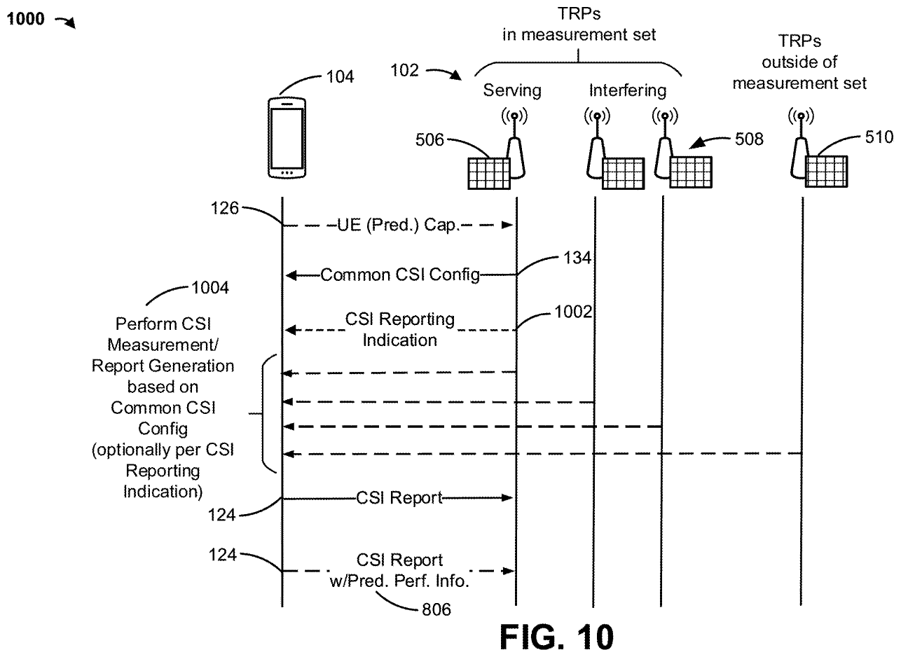

Also, in some alternative or additional aspects, a larger set of tuples 504 can be configured by the network for the UE 104 in advance, such as via radio resource control (RRC) signaling. Then, one or more tuples 504 can be configured for the CSI report 124 from this large set via one or more dynamic CSI reporting indications 1002 (see FIG. 10), such as using MAC-CE or DCI.

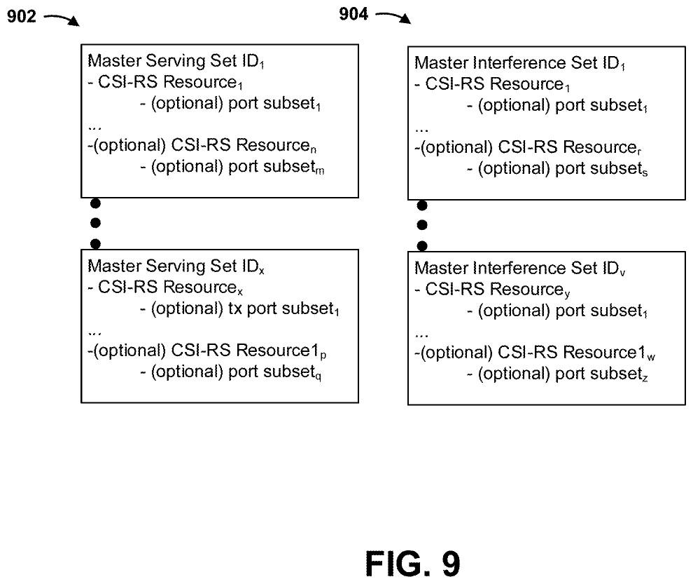

Optionally, in some implementations, referring specifically to FIG. 9, a master serving set identifier (ID) 902 associated with a compound set of multiple serving CSI-RS resource configurations 514 (e.g., TRPs) (and, optionally with their default subset of ports) and/or a master interfering set ID 904 associated with a compound set of multiple interfering CSI-RS resource configurations 516 (e.g., TRPs) (and, optionally with their default subset of ports 520) can be created. These master IDs can be indicated in a sub-configuration 502 or tuple 504 with or without associated subsets of ports 518 and 520, with default subsets used in the latter case. The UE 104 can obtain the channel estimates for the respective subset of ports 518 and 520 for the sub-configuration 502 using constituent CSI-RS resource configurations 514 and 516 and associated indicated additional information or additional parameters 512.

Moreover, in some options that may be combined with any other option herein, each sub-configuration 502 can have an associated time-offset and an implicit reference, which may be indicated in the additional parameters 512. The time-offset (in slots or symbols) and reference identify the time-stamp for the channel prediction. Absence of a time-offset implies no prediction is needed and the CSI is to be computed using the estimates measured on corresponding CSI-RS resource configurations 514, 516 without prediction, which is referred to as a current CSI.

In still other alternative or additional implementations, for example, for each subset of the serving hypothesis 506 and the interference hypothesis 508 in a sub-configuration 502 or tuple 504, the UE 104 can apply a prediction mechanism, such as prediction component 128, to obtain future channel estimates for the subset of the serving hypothesis 506 and the interference hypothesis 508 over each constituent associated CSI-RS resource configuration 514 and 516 and a time-offset that may be indicated in the additional parameters 512. This is based on the channel estimated using the corresponding CSI-RS resource configuration 514 and 516 and past CSI estimate information 129. For example, in some aspects, prediction component 128 includes one or more predictions mechanisms such as an algorithm or function or artificial intelligence model and/or machine learning model capable of extrapolating or otherwise predicting future CSI parameters based on current CSI parameters, and in some cases taking into account historical CSI parameters and measurements. In some cases, a network device such as base station 102 may provide UE 104 with one or more such prediction mechanisms (as mentioned above with respect to FIG. 4), and/or may indicate to the UE 104 which prediction mechanism to utilize.

Moreover, in some alternative or additional aspects, the power-offset 524 indicated for the CSI-RS resource configuration 516 corresponding to each interference hypothesis 508 (e.g., each tuple 504) is used towards the scaling used to compute its interference covariance. Analogously, the power-offset 522 of the CSI-RS resource configuration 514 corresponding to each subset of the serving hypothesis 506 is used for the signal part.

Additionally, in some alternative or additional aspects, for enabling the UE 104 to determine interference covariance, the choice of interfering precoder(s) or their induced covariance is indicated, such as in the additional parameters 512. Examples include an isotropic precoder (optionally with a maximum rank indication), which results in a scaled identity matrix induced covariance, with the scaling factor being a function of rank; a PMI codebook subset from an identified codebook (default: equi-likely distribution of precoder matrices from codebook corresponding to PMI indices in subset); or a precoder covariance matrix indication.

Further, in some alternative or additional aspects, a vector of time-offsets or frequency offsets can be indicated with the tuple 504, such as via the additional parameters 512. For instance, the vector of time-offsets or frequency offsets may be a series of values that indicate a respective time-offset or frequency offset, either based on a reference value or based on a prior value in the series, to be utilized on a corresponding one of a series of CSI measurements. In this case, the UE 104 provides the CSI report 124 for each entry. In some implementations, the CSI reports 124 or the information of the CSI report 124 is provided in order so the association of the report with the entry is implicit. Also, in this case, the UE 104 can report a confidence measure along with CSI indicated for each entry of the vector, as also highlighted in the next slide.

In some alternative or additional aspects, the time offset as indicated by the additional parameter 512 could be an interval, and the UE 104 can report CSI computed for that interval further averaged according to a probability distribution.

Additionally, in some alternative or additional aspects, new UE capabilities and guidelines for CSI acquisition under multiple serving and interference hypotheses are enabled by the present disclosure.

Specifically, examples include codebook-type, PMI subset, and or rank being separately restricted for CSI feedback associated with each sub-configuration 502 or tuple 504, as may be indicated by the additional parameters 512.

Alternatively, CSI report settings with restrictions can be assumed to be the same across tuples 504. For instance, CSI report settings can be configured to be the same as used for a reference tuple 504, as may be indicated by the additional parameters 512.

Also, in some alternate or additional aspects, an implicit rule can be configured under which multiple tuples 504 can reuse the same PMI or rank, as may be indicated by the additional parameters 512. CSI report settings can be configured, via additional parameters 512, to be the same across tuples 504 containing a subset of a common dominant interferer, e.g., associated with the interference hypothesis 508, with the dominant one determined by a configured rule or reference signal received power (RSRP) threshold, which may be provided in the additional parameters 512.

Moreover, in some alternative or additional aspects, the CSI-resource bandwidth that needs to be monitored or measured for a neighbor CSI-RS resource (e.g., TRP) can be restricted, separately per neighbor and/or across all neighbor CSI-RS resources (e.g., TRPs) in the measurement group, as may be indicated by the additional parameters 512.

Further, as may be indicated in the additional parameters 512 or elsewhere in the common CSI configuration 134, in some alternative or additional aspects, the number of central processing unit (CPU) or application processing unit (APU) cycles can be shared across all sub-configurations 502, optionally with additional per tuple limits. Also, dropping rules can be defined in the additional parameters 512 to enable the CSI reporting component 122 to prioritize the CSI reports 124 for some sub-configurations 502 or tuples 504 over others, given a limited CPU or APU budget.

Moreover, in alternative or additional aspects, the timeline for the CSI reports 124 can depend on configured sub-configurations 502 or tuples 504, associated time-offsets (as indicated in additional parameters 512), and UE prediction capability (as indicated by the UE capability 126), such as timelines for AI or ML inference.

In an alternative or additional aspect, the UE capability 126 that is reported can indicate prediction capability. The UE capability 126 can also indicate cross-frequency sub-band or component carrier prediction capability. The CSI report 124 can also indicate confidence per-CSI-RS resource (e.g., TRP) or per-tuple as a function of time or frequency offset, which may be determined by the prediction component 26 and indicated by prediction performance information 806. For example, the quality of the predicted channel versus time-offset or frequency offset can be reported in terms of an expectation over a distance norm of the difference between the true and predicted channel, such as expected mean-squared error, chordal distance, or cosine distance. As the past CSI estimate information 129 for different sub-configurations 502 might have happened at different epochs, the UE 104 could report information about those past epochs separately, or just encapsulate all such information into a confidence reported per sub-configuration 502, such as in prediction performance information 806.

Further, in alternative or additional aspects, the network can configure the UE 104 according to UE capability 126 or recommendations for combinations of multiple modes of prediction. Such configuration may be indicated in the additional parameters 512. These modes of prediction include temporal prediction only, where the serving or interference hypotheses (e.g., antenna subset channel) is measured and then prediction is performed for the same subset of hypotheses (same subset channel) for a future time. Also, another mode of prediction is prediction across subsets (the same subset of hypotheses) within the same CSI-RS resource, where a subset of serving or interfering ports is measured and another subset is predicted for the same CSI-RS resource. A further mode of prediction includes prediction across different CSI-RS resources, where a subset of serving or interference hypotheses (e.g., ports) of a CSI-RS resource is measured and another subset of a different resource is predicted. Any one or combination of these three prediction types can be used.

Additionally, or in the alternative, an aspect includes the network performing intermittent validity check(s) to assess prediction accuracy and/or quality. In one example implementation, the UE 104 executing the prediction component 128 predicts CSI under a specific one or more serving or interference hypothesis 506 or 508, such as a specific sub-configuration 502 including one or more subsets of serving or interfering CSI-RS resource configurations 514, 516 (e.g., TRPs). Further, for example, the UE 104 can be configured via the common CSI configuration 134 with monitoring a signal (e.g., a reference signal) where those serving or interfering CSI-RS resource configurations 514, 516 (e.g., TRPs) transmit according to the sub-configuration 502, that is, via the same ports, power offsets, and matched interfering precoding covariance. The UE 104 then compares its predicted interference or CSI with the actual measured interference or CSI to quantify and report its prediction performance, e.g., via prediction performance information 806, to the network or base station 102. Based on prediction accuracy, the network/base station 102 or UE 104 (e.g., via the prediction component 128) can take different decisions, for example, deciding whether to curtail or expand prediction by altering the indicated offset range, or finetune or switch the indicated choice of prediction algorithm.

Referring specifically to FIG. 10, an example messaging flow 1000 summarizes aspects of the present disclosure, including a serving base station 102 in a measurement set of the UE 104 transmitting the common CSI configuration 134 to the UE 104 to configure the UE 104 for multi-hypothesis CSI measurement and reporting. In some cases, the common CSI configuration 134 may be based on UE capability 126, such as relating to processing and/or prediction abilities. Further, either the common CSI configuration 134 will implicitly indicate the subset of sub-configurations 502 for measurement and reporting, or a separate, dynamic CSI reporting indication 1002 such as a MAC-CE or DCI can be used transmitted by the base station 102 to the UE 104 to provide the indication. The indication of the subset of sub-configurations 502 identify sets of serving hypotheses 506 and interference hypotheses 508 or outside interference indications 510 to use. As such, only a single, common CSI configuration 134 is sent by the base station 102, but a plurality of different hypotheses can easily and efficiently to indicated. In any case, at 1004, the UE 104 performs the CSI measurements and then generates and transmits the CSI report 124. In some cases, the CSI report 124 can include prediction performance information 806, as described above.

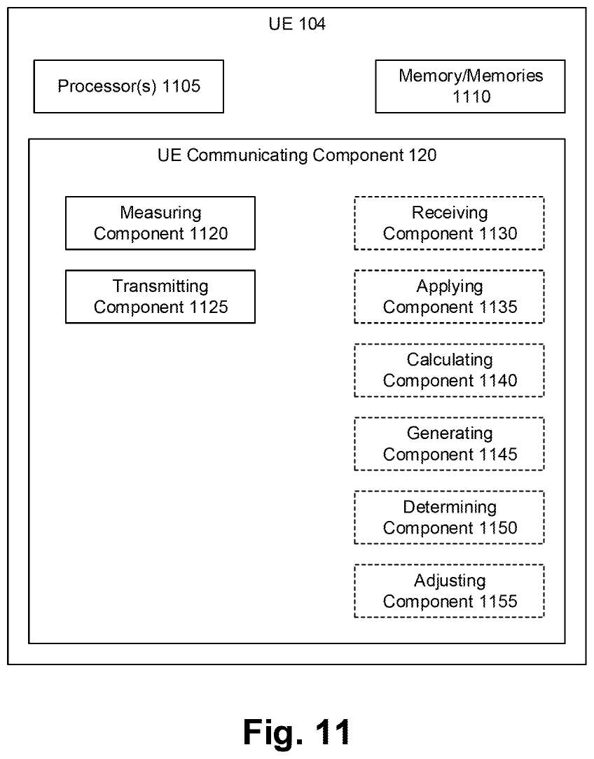

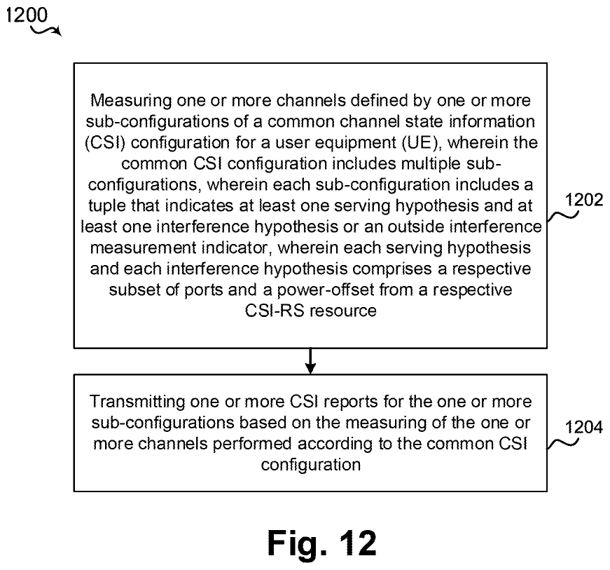

Referring to FIGS. 11 and 12, in operation, UE 104 may perform a method 1200 of wireless communication, such as via execution of UE communicating component 120 by one or more processors 1105 configured, individually or in any combination, to execute instructions to perform the following actions, and/or configured to communicate with one or more memories 1110 to obtain the instructions and perform the actions.

At block 1202, the method 1200 includes measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. For example, in an aspect, UE 104, one or more processors 1105, one or more memories 1110, UE communicating component 120, and/or measuring component 1120 may be configured to or may comprise means for measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource.

For example, the measuring at block 1202 may include the actions described in detail in the above one or more aspects.

At block 1204, the method 1200 includes transmitting one or more CSI reports for the one or more sub-configurations based on the measuring of the one or more channels performed according to the common CSI configuration. For example, in an aspect, UE 104, one or more processors 1105, one or more memories 1110, UE communicating component 120, and/or transmitting component 1125 may be configured to or may comprise means for transmitting one or more CSI reports for the one or more sub-configurations based on the measuring of the one or more channels performed according to the common CSI configuration.

For example, the transmitting at block 1204 may include the actions described in detail in the above one or more aspects.

In an alternative or additional aspect, a number of the one or more sub-configurations of the one or more channels being measured is less than a total number of the multiple sub-configurations of the common CSI configuration.

In an alternative or additional aspect, wherein, for each sub-configuration, ports of each respective subset of ports of each CSI-RS resource for each serving hypothesis are different from ports of each respective subset of ports of a same CSI-RS resource for each interference hypothesis.

In an alternative or additional aspect, each serving hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

In an alternative or additional aspect, each interference hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

In an alternative or additional aspect, each CSI report of a respective sub-configuration of the multiple sub-configurations is based on configured parameters of the respective sub-configuration, wherein the configured parameters include one or more of a CSI report type, a rank indicator, wideband and/or sub-band precoding matrix indicator and/or channel quality information, and/or the outside interference indicator.

In an alternative or additional aspect, each tuple of each sub-configuration is indicated using a variable-length indication.

In an alternative or additional aspect, the UE is configured with a CSI-RS resource for each TRP in a measurement set of TRPs, and a respective interference measurement resource (IMR) or a respective CSI-interference measurement (IM) resource that corresponds to each outside interference indicator. In this aspect, at least one sub-configuration includes a respective serving hypothesis comprising multiple TRPs of one or more TRPs in the measurement set of TRPs.

In an alternative or additional aspect, at least one sub-configuration includes a same CSI-RS resource of the one or more CSI-RS resources in a respective serving hypothesis and a respective interference hypothesis, with different subsets of ports in the respective serving hypothesis and the respective interference hypothesis.

In an alternative or additional aspect, the common CSI configuration comprises a plurality of sub-configurations having a same serving hypothesis and a different respective interference hypothesis.

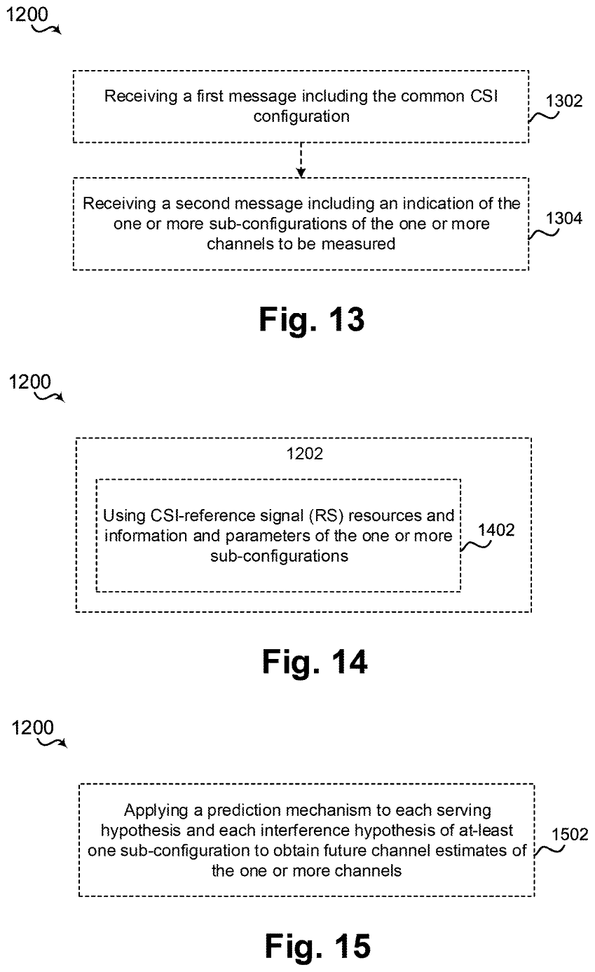

Referring to FIG. 13, in an alternative or additional aspect, at block 1302, the method 1200 may further include receiving a first message including the common CSI configuration. For example, in an aspect, UE 104, one or more processors 1105, one or more memories 1110, UE communicating component 120, and/or receiving component 1130 may be configured to or may comprise means for receiving a first message including the common CSI configuration.

For example, the receiving at block 1302 may include the actions described in detail in the above one or more aspects.

In this optional aspect, at block 1304, the method 1200 may further include receiving a second message including an indication of the one or more sub-configurations of the one or more channels to be measured. For example, in an aspect, UE 104, one or more processors 1105, one or more memories 1110, UE communicating component 120, and/or receiving component 1130 may be configured to or may comprise means for receiving a second message including an indication of the one or more sub-configurations of the one or more channels to be measured.

For example, the receiving at block 1304 may include the actions described in detail in the above one or more aspects.

In an alternative or additional aspect, each sub-configuration or each tuple indicates at least one master serving set identifier and at least one a master interference set identifier, wherein each master serving set identifier corresponds with a respective at least one serving hypothesis, and wherein each master interference set identifier corresponds with a respective at least one interference hypothesis.

Referring to FIG. 14, in an alternative or additional aspect, at block 1402, the measuring at block 1202 of the one or more channels comprises using CSI-reference signal (RS) resources and information and parameters of the one or more sub-configurations, as described above.

In an alternative or additional aspect, each sub-configuration includes an associated time-offset indication and a reference value, wherein the time-offset indication and the reference value identify a time stamp for a channel prediction, wherein in a case where the time-offset indication indicates an absence of a time-offset value then no prediction is needed and a CSI for the respective CSI report is to be computed using estimates measured on corresponding CSI-reference signal (RS) resources without prediction.

In an alternative or additional aspect, the one or more CSI reports include at least one of a current CSI report or a predicted future CSI report.

Referring to FIG. 15, in an alternative or additional aspect, at block 1502, the method 1200 may further include applying a prediction mechanism to each serving hypothesis and each interference hypothesis of at-least one sub-configuration to obtain future channel estimates of the one or more channels. For example, in an aspect, UE 104, one or more processors 1105, one or more memories 1110, UE communicating component 120, and/or applying component 1135 may be configured to or may comprise means for applying a prediction mechanism to each serving hypothesis and each interference hypothesis of at-least one sub-configuration to obtain future channel estimates of the one or more channels.

For example, the applying at block 1502 may include the actions described in detail in the above one or more aspects.

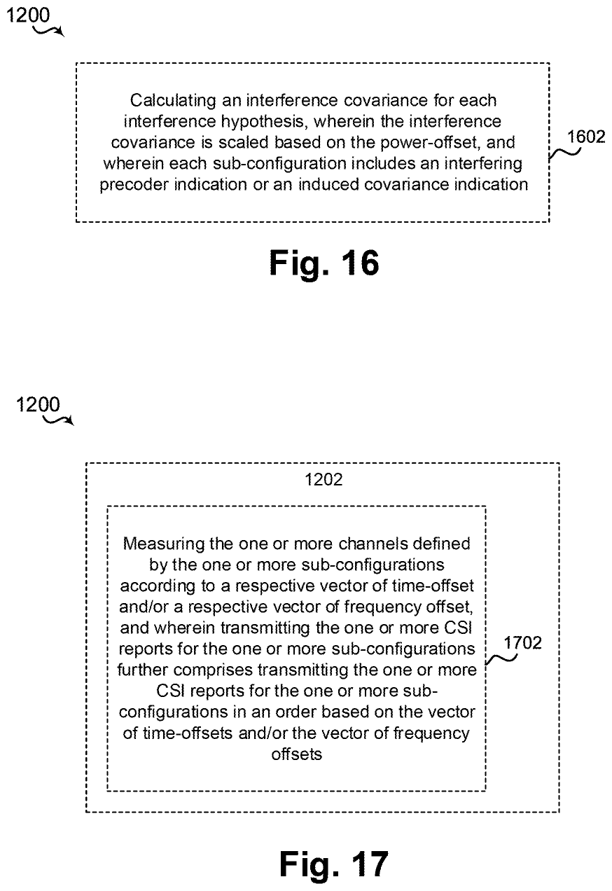

Referring to FIG. 16, in an alternative or additional aspect, at block 1602, the method 1200 may further include calculating an interference covariance for each interference hypothesis, wherein the interference covariance is scaled based on the power-offset, and wherein each sub-configuration includes an interfering precoder indication or an induced covariance indication. For example, in an aspect, UE 104, one or more processors 1105, one or more memories 1110, UE communicating component 120, and/or calculating component 1140 may be configured to or may comprise means for calculating an interference covariance for each interference hypothesis, wherein the interference covariance is scaled based on the power-offset, and wherein each sub-configuration includes an interfering precoder indication or an induced covariance indication.

For example, the calculating at block 1602 may include the actions described in detail in the above one or more aspects.

Referring to FIG. 17, in an alternative or additional aspect, at block 1702, the measuring at block 1202 of the one or more channels defined by the one or more sub-configurations further comprises measuring the one or more channels defined by the one or more sub-configurations according to a respective vector of time-offset and/or a respective vector of frequency offset, and wherein transmitting the one or more CSI reports for the one or more sub-configurations further comprises transmitting the one or more CSI reports for the one or more sub-configurations in an order based on the vector of time-offsets and/or the vector of frequency offsets, as described above.

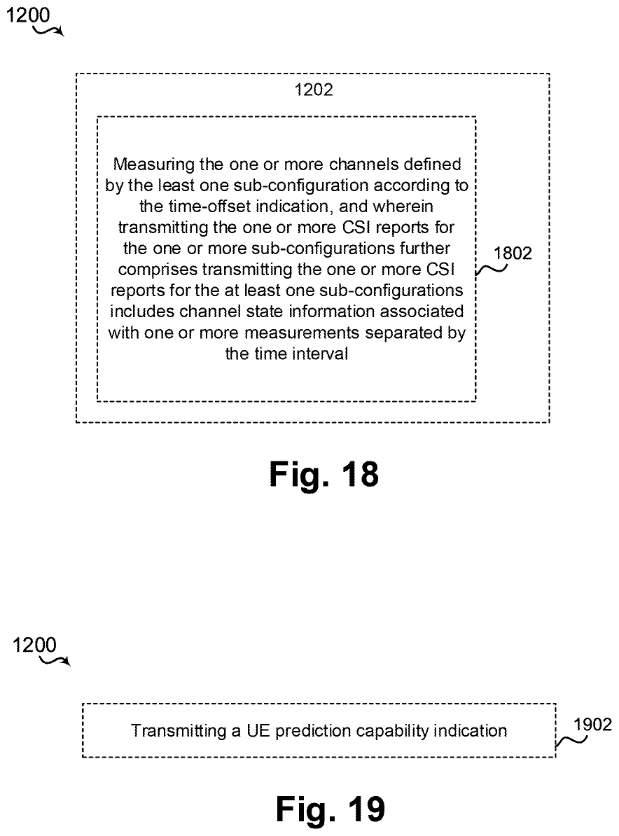

Referring to FIG. 18, in an alternative or additional aspect, at block 1802, the measuring at block 1202 of the one or more channels defined by the one or more sub-configurations further comprises measuring the one or more channels defined by the least one sub-configuration according to the time-offset indication, and wherein transmitting the one or more CSI reports for the one or more sub-configurations further comprises transmitting the one or more CSI reports for the at least one sub-configurations includes channel state information associated with one or more measurements separated by the time interval, as described above.

In an alternative or additional aspect, at least a portion of the one or more sub-configurations are associated with a fixed codebook type, a fixed precoding matrix indicator, and/or a fixed rank.

In an alternative or additional aspect, the one or more CSI reports for the one or more sub-configurations include a same set of reporting settings across multiple ones of the one or more sub-configurations.

In an alternative or additional aspect, a same set of reporting settings across multiple ones of the one or more sub-configurations are configured based on an explicit indicator or based on an implicit indication.

In an alternative or additional aspect, at least a portion of the one or more sub-configurations define a CSI-resource bandwidth used to measure a neighboring CSI-RS resource.

In an alternative or additional aspect, the one or more sub-configurations include a same central processing unit cycle setting and/or a same application processing unit cycle setting.

In an alternative or additional aspect, the one or more sub-configurations each include one of a plurality of central processing unit resource priority ranks and/or one of a plurality of application processing unit resource priority ranks associated with a corresponding CSI report, and wherein the UE further comprises one or more processing rules configured to prioritize respective CSI reports based on the respective one of the plurality of central processing unit resource priority ranks and/or the respective one of the plurality of application processing unit resource priority ranks.

In an alternative or additional aspect, respective timelines for transmitting each of the one or more CSI reports depends on a report timing parameter of each sub-configuration, a time-offset indication of each sub-configuration, and/or a UE prediction capability.

Referring to FIG. 19, in an alternative or additional aspect, at block 1902, the method 1200 may further include transmitting a UE prediction capability indication. For example, in an aspect, UE 104, one or more processors 1105, one or more memories 1110, UE communicating component 120, and/or transmitting component 1125 may be configured to or may comprise means for transmitting a UE prediction capability indication.

For example, the transmitting at block 1902 may include the actions described in detail in the above one or more aspects.

In an alternative or additional aspect, the UE prediction capability indication includes a cross-frequency sub-band prediction capability and/or a component carrier prediction capability.

In an alternative or additional aspect, the one or more CSI reports include a per-CSI-RS resource confidence value or a per-tuple confidence value as a function of a time-offset and/or as a function of a frequency offset.

In an alternative or additional aspect, the one or more sub-configurations include one or more prediction parameters that are a function of the UE prediction capability indication, and wherein the one or more prediction parameters include a temporal prediction only indicator, a cross-subset with same CSI resource prediction indicator, a cross CSI resource prediction indicator, or any combination thereof.

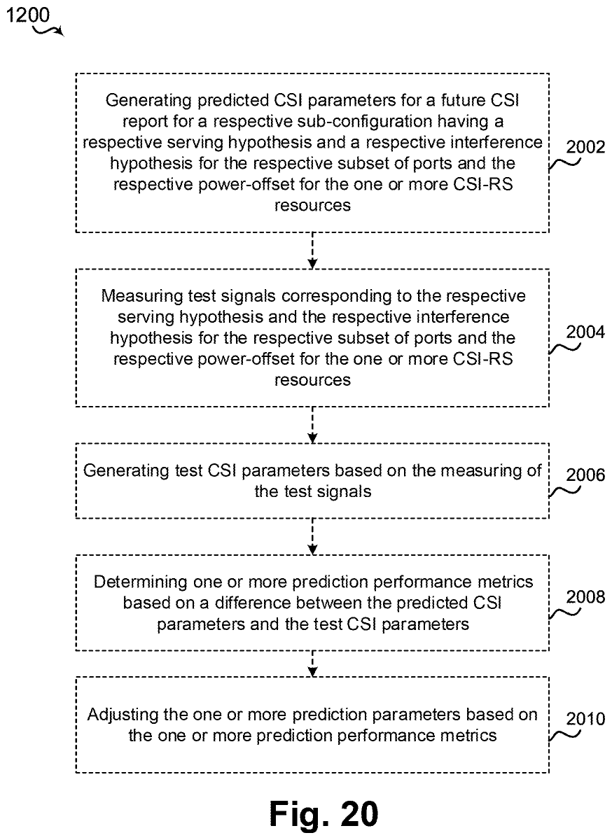

Referring to FIG. 20, in an alternative or additional aspect, at block 2002, the method 1200 may further include generating predicted CSI parameters for a future CSI report for a respective sub-configuration having a respective serving hypothesis and a respective interference hypothesis for the respective subset of ports and the respective power-offset for the one or more CSI-RS resources. For example, in an aspect, UE 104, one or more processors 1105, one or more memories 1110, UE communicating component 120, and/or generating component 1145 may be configured to or may comprise means for generating predicted CSI parameters for a future CSI report for a respective sub-configuration having a respective serving hypothesis and a respective interference hypothesis for the respective subset of ports and the respective power-offset for the one or more CSI-RS resources.

For example, the generating at block 2002 may include the actions described in detail in the above one or more aspects.

In this optional aspect, at block 2004, the method 1200 may further include measuring test signals corresponding to the respective serving hypothesis and the respective interference hypothesis for the respective subset of ports and the respective power-offset for the one or more CSI-RS resources;. For example, in an aspect, UE 104, one or more processors 1105, one or more memories 1110, UE communicating component 120, and/or measuring component 1120 may be configured to or may comprise means for measuring test signals corresponding to the respective serving hypothesis and the respective interference hypothesis for the respective subset of ports and the respective power-offset for the one or more CSI-RS resources;.

For example, the measuring at block 2004 may include the actions described in detail in the above one or more aspects.

In this optional aspect, at block 2006, the method 1200 may further include generating test CSI parameters based on the measuring of the test signals;. For example, in an aspect, UE 104, one or more processors 1105, one or more memories 1110, UE communicating component 120, and/or generating component 1145 may be configured to or may comprise means for generating test CSI parameters based on the measuring of the test signals.

For example, the generating at block 2006 may include the actions described in detail in the above one or more aspects.

In this optional aspect, at block 2008, the method 1200 may further include determining one or more prediction performance metrics based on a difference between the predicted CSI parameters and the test CSI parameters. For example, in an aspect, UE 104, one or more processors 1105, one or more memories 1110, UE communicating component 120, and/or determining component 1150 may be configured to or may comprise means for determining one or more prediction performance metrics based on a difference between the predicted CSI parameters and the test CSI parameters.

For example, the determining at block 2008 may include the actions described in detail in the above one or more aspects.

In this optional aspect, at block 2010, the method 1200 may further include adjusting the one or more prediction parameters based on the one or more prediction performance metrics. For example, in an aspect, UE 104, one or more processors 1105, one or more memories 1110, UE communicating component 120, and/or adjusting component 1155 may be configured to or may comprise means for adjusting the one or more prediction parameters based on the one or more prediction performance metrics.

For example, the adjusting at block 2010 may include the actions described in detail in the above one or more aspects.

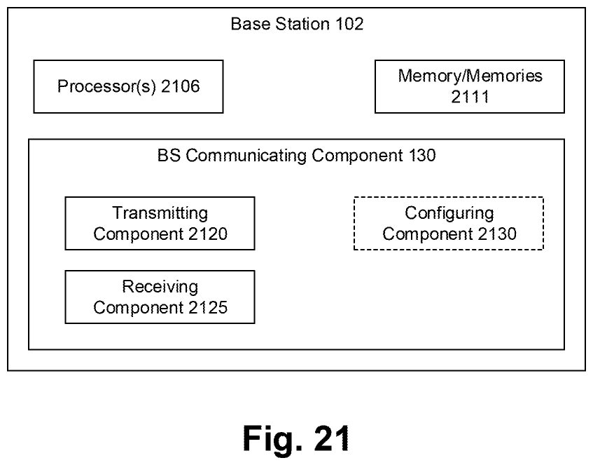

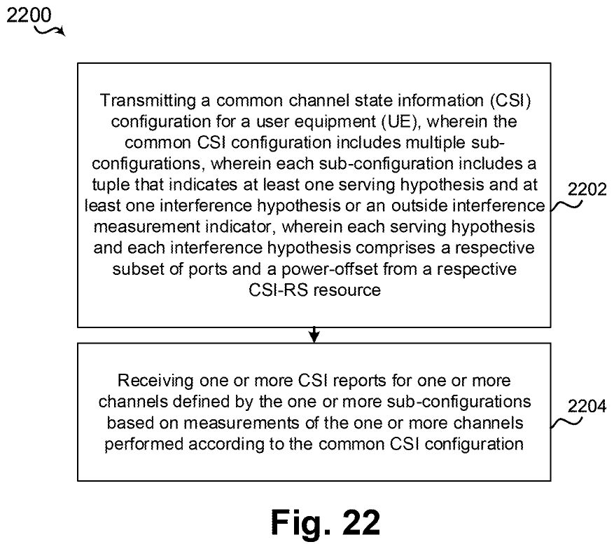

Referring to FIG. 21 and FIG. 22, in operation, base station 102 may perform a method 2200 of wireless communication, such as via execution of BS computing component 130 by one or more processors 2106 configured, individually or in any combination, to execute instructions to perform the following actions, and/or configured to communicate with one or more memories 2111 to obtain the instructions.

At block 2202, the method 2200 includes transmitting a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource. For example, in an aspect, base station 102, one or more processors 2106, one or more memories 2111, BS computing component 130, and/or transmitting component 2120 may be configured to or may comprise means for transmitting a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource.

For example, the transmitting at block 2202 may include the actions described in detail in the above one or more aspects.

At block 2204, the method 2200 includes receiving one or more CSI reports for one or more channels defined by the one or more sub-configurations based on measurements of the one or more channels performed according to the common CSI configuration. For example, in an aspect, base station 102, one or more processors 2106, one or more memories 2111, BS computing component 130, and/or receiving component 2125 may be configured to or may comprise means for receiving one or more CSI reports for one or more channels defined by the one or more sub-configurations based on measurements of the one or more channels performed according to the common CSI configuration.

For example, the receiving at block 2204 may include the actions described in detail in the above one or more aspects.

In an alternative or additional aspect, a number of the one or more sub-configurations of the one or more channels being measured is less than a total number of the multiple sub-configurations of the common CSI configuration.

In an alternative or additional aspect, wherein, for each sub-configuration, ports of each respective subset of ports of each CSI-RS resource for each serving hypothesis are different from ports of each respective subset of ports of a same CSI-RS resource for each interference hypothesis.

In an alternative or additional aspect, each serving hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

In an alternative or additional aspect, each interference hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

In an alternative or additional aspect, each CSI report of a respective sub-configuration of the multiple sub-configurations is based on configured parameters of the respective sub-configuration, wherein the configured parameters include one or more of a CSI report type, a rank indicator, wideband and/or sub-band precoding matrix indicator and/or channel quality information, and/or the outside interference indicator.

In an alternative or additional aspect, each tuple of each sub-configuration is indicated using a variable-length indication.

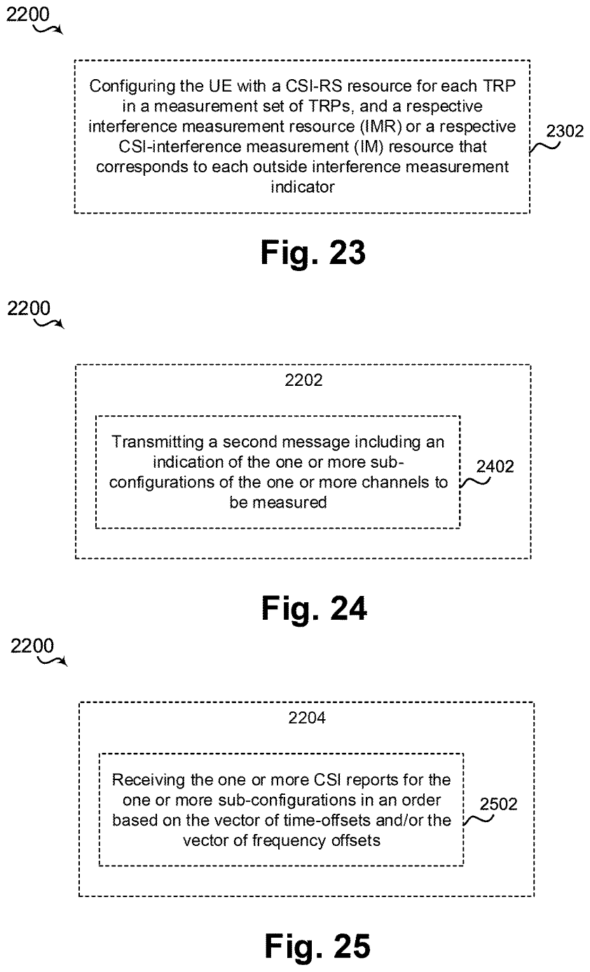

Referring to FIG. 23, in an alternative or additional aspect, at block 2302, the method 2200 may further include configuring the UE with a CSI-RS resource for each TRP in a measurement set of TRPs, and a respective interference measurement resource (IMR) or a respective CSI-interference measurement (IM) resource that corresponds to each outside interference indicator. For example, in an aspect, base station 102, one or more processors 2106, one or more memories 2111, BS computing component 130, and/or configuring component 2130 may be configured to or may comprise means for configuring the UE with a CSI-RS resource for each TRP in a measurement set of TRPs, and a respective interference measurement resource (IMR) or a respective CSI-interference measurement (IM) resource that corresponds to each outside interference indicator.

For example, the configuring at block 2302 may include the actions described in detail in the above one or more aspects.

In an alternative or additional aspect, at least one sub-configuration includes a respective serving hypothesis comprising multiple TRPs of one or more TRPs in the measurement set of TRPs.

In an alternative or additional aspect, at least one sub-configuration includes a same CSI-RS resource of the one or more CSI-RS resources in a respective serving hypothesis and a respective interference hypothesis, with different subsets of ports in the respective serving hypothesis and the respective interference hypothesis.

In an alternative or additional aspect, the common CSI configuration comprises a plurality of sub-configurations having a same serving hypothesis and a different respective interference hypothesis.

Referring to FIG. 24, in an alternative or additional aspect, at block 2402, the transmitting at block 2202 of the common CSI configuration comprises transmitting a first message; and further comprises transmitting a second message including an indication of the one or more sub-configurations of the one or more channels to be measured, as described above.

In an alternative or additional aspect, each sub-configuration or each tuple indicates at least one master serving set identifier and at least one a master interference set identifier, wherein each master serving set identifier corresponds with a respective at least one serving hypothesis, and wherein each master interference set identifier corresponds with a respective at least one interference hypothesis.

In an alternative or additional aspect, the UE is configured to measure the one or more channels using CSI-reference signal (RS) resources and information and parameters of the one or more sub-configurations.

In an alternative or additional aspect, each sub-configuration includes an associated time-offset indication and a reference value, wherein the time-offset indication and the reference value identify a time stamp for a channel prediction, wherein in a case where the time-offset indication indicates an absence of a time-offset value then no prediction is needed and a CSI for the respective CSI report is to be computed using estimates measured on corresponding CSI-reference signal (RS) resources without prediction. In this aspect, the common CSI configuration indicates to apply a prediction mechanism to each serving hypothesis and each interference hypothesis of at-least one sub-configuration to obtain future channel estimates of the one or more channels.

In an alternative or additional aspect, the common CSI configuration indicates to calculate an interference covariance for each interference hypothesis, wherein the interference covariance is scaled based on the power-offset, and wherein each sub-configuration includes an interfering precoder indication or an induced covariance indication for calculating the interference covariance for each interference hypothesis.

Referring to FIG. 25, in an alternative or additional aspect, at block 2502, the receiving at block 2204 of the one or more CSI reports for the one or more sub-configurations further comprises receiving the one or more CSI reports for the one or more sub-configurations in an order based on the vector of time-offsets and/or the vector of frequency offsets, as described above.

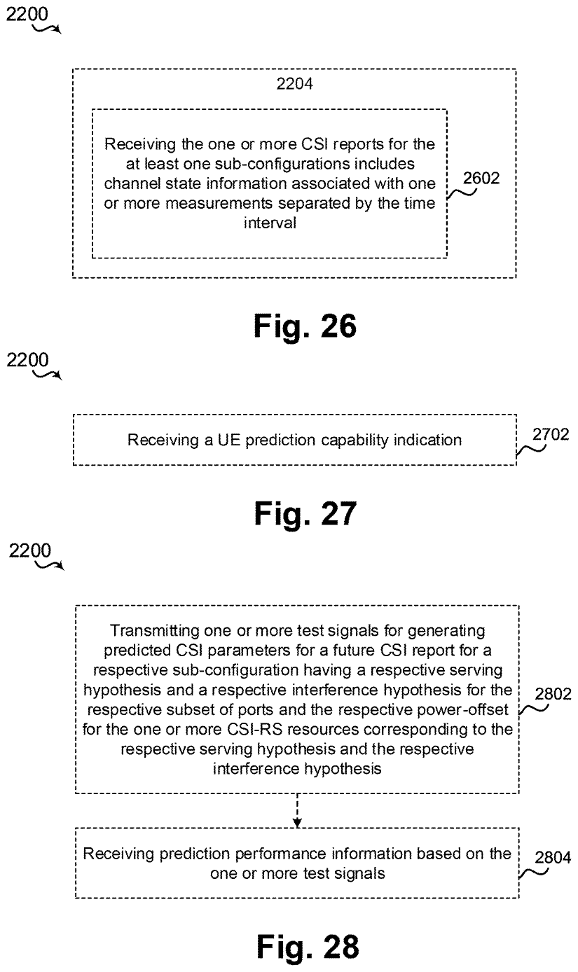

Referring to FIG. 26, in an alternative or additional aspect, at block 2602, the receiving at block 2204 of the one or more CSI reports for the one or more sub-configurations further comprises receiving the one or more CSI reports for the at least one sub-configurations includes channel state information associated with one or more measurements separated by the time interval, as described above.

In an alternative or additional aspect, at least a portion of the one or more sub-configurations are associated with a fixed codebook type, a fixed precoding matrix indicator, and/or a fixed rank.

In an alternative or additional aspect, the one or more CSI reports for the one or more sub-configurations include a same set of reporting settings across multiple ones of the one or more sub-configurations.

In an alternative or additional aspect, a same set of reporting settings across multiple ones of the one or more sub-configurations are configured based on an explicit indicator or based on an implicit indication.

In an alternative or additional aspect, at least a portion of the one or more sub-configurations define a CSI-resource bandwidth used to measure a neighboring CSI-RS resource.

In an alternative or additional aspect, the one or more sub-configurations include a same central processing unit cycle setting and/or a same application processing unit cycle setting.

In an alternative or additional aspect, the one or more sub-configurations each include one of a plurality of central processing unit resource priority ranks and/or one of a plurality of application processing unit resource priority ranks associated with a corresponding CSI report, and wherein the one or more sub-configurations each include one or more processing rules configured to prioritize respective CSI reports based on the respective one of the plurality of central processing unit resource priority ranks and/or the respective one of the plurality of application processing unit resource priority ranks.

In an alternative or additional aspect, respective timelines for the UE to transmit each of the one or more CSI reports depends on a report timing parameter of each sub-configuration, a time-offset indication of each sub-configuration, and/or a UE prediction capability.

Referring to FIG. 27, in an alternative or additional aspect, at block 2702, the method 2200 may further include receiving a UE prediction capability indication. For example, in an aspect, base station 102, one or more processors 2106, one or more memories 2111, BS computing component 130, and/or receiving component 2125 may be configured to or may comprise means for receiving a UE prediction capability indication.

For example, the receiving at block 2702 may include the actions described in detail in the above one or more aspects.

In an alternative or additional aspect, the UE prediction capability indication includes a cross-frequency sub-band prediction capability and/or a component carrier prediction capability.

In an alternative or additional aspect, the one or more CSI reports include a per-CSI-RS resource confidence value or a per-tuple confidence value as a function of a time-offset and/or as a function of a frequency offset.

In an alternative or additional aspect, the one or more sub-configurations include one or more prediction parameters that are a function of the UE prediction capability indication, and wherein the one or more prediction parameters include a temporal prediction only indicator, a cross-subset with same CSI resource prediction indicator, a cross CSI resource prediction indicator, or any combination thereof.

Referring to FIG. 28, in an alternative or additional aspect, at block 2802, the method 2200 may further include transmitting one or more test signals for generating predicted CSI parameters for a future CSI report for a respective sub-configuration having a respective serving hypothesis and a respective interference hypothesis for the respective subset of ports and the respective power-offset for the one or more CSI-RS resources corresponding to the respective serving hypothesis and the respective interference hypothesis. For example, in an aspect, base station 102, one or more processors 2106, one or more memories 2111, BS computing component 130, and/or transmitting component 2120 may be configured to or may comprise means for transmitting one or more test signals for generating predicted CSI parameters for a future CSI report for a respective sub-configuration having a respective serving hypothesis and a respective interference hypothesis for the respective subset of ports and the respective power-offset for the one or more CSI-RS resources corresponding to the respective serving hypothesis and the respective interference hypothesis.

For example, the transmitting at block 2802 may include the actions described in detail in the above one or more aspects.

In this optional aspect, at block 2804, the method 2200 may further include receiving prediction performance information based on the one or more test signals. For example, in an aspect, base station 102, one or more processors 2106, one or more memories 2111, BS computing component 130, and/or receiving component 2125 may be configured to or may comprise means for receiving prediction performance information based on the one or more test signals.

For example, the receiving at block 2804 may include the actions described in detail in the above one or more aspects.

The above aspects may be implemented according to one or any combination of the following clauses.

Clause 1. A method of wireless communication, comprising: measuring one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource; and transmitting one or more CSI reports for the one or more sub-configurations based on the measuring of the one or more channels performed according to the common CSI configuration.

Clause 2. The method of clause 1, wherein a number of the one or more sub-configurations of the one or more channels being measured is less than a total number of the multiple sub-configurations of the common CSI configuration.

Clause 3. The method of any preceding clause, wherein, for each sub-configuration, ports of each respective subset of ports of each CSI-RS resource for each serving hypothesis are different from ports of each respective subset of ports of a same CSI-RS resource for each interference hypothesis.

Clause 4. The method of any preceding clause, wherein each serving hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

Clause 5. The method of any preceding clause, wherein each interference hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

Clause 6. The method of any preceding clause, wherein each CSI report of a respective sub-configuration of the multiple sub-configurations is based on configured parameters of the respective sub-configuration, wherein the configured parameters include one or more of a CSI report type, a rank indicator, wideband and/or sub-band precoding matrix indicator and/or channel quality information, and/or the outside interference indicator.

Clause 7. The method of any preceding clause, wherein each tuple of each sub-configuration is indicated using a variable-length indication.

Clause 8. The method of any preceding clause, wherein the UE is configured with a CSI-RS resource for each TRP in a measurement set of TRPs, and a respective interference measurement resource (IMR) or a respective CSI-interference measurement (IM) resource that corresponds to each outside interference indicator.

Clause 9. The method of clause 8, wherein at least one sub-configuration includes a respective serving hypothesis comprising multiple TRPs of one or more TRPs in the measurement set of TRPs.

Clause 10. The method of any preceding clause, wherein at least one sub-configuration includes a same CSI-RS resource of the one or more CSI-RS resources in a respective serving hypothesis and a respective interference hypothesis, with different subsets of ports in the respective serving hypothesis and the respective interference hypothesis.

Clause 11. The method of any preceding clause, wherein the common CSI configuration comprises a plurality of sub-configurations having a same serving hypothesis and a different respective interference hypothesis.

Clause 12. The method of any preceding clause, further comprising: receiving a first message including the common CSI configuration; and receiving a second message including an indication of the one or more sub-configurations of the one or more channels to be measured.

Clause 13. The method of any preceding clause, wherein each sub-configuration or each tuple indicates at least one master serving set identifier and at least one a master interference set identifier, wherein each master serving set identifier corresponds with a respective at least one serving hypothesis, and wherein each master interference set identifier corresponds with a respective at least one interference hypothesis.

Clause 14. The method of any preceding clause, wherein measuring the one or more channels comprises using CSI-reference signal (RS) resources and information and parameters of the one or more sub-configurations.

Clause 15. The method of any preceding clause, wherein each sub-configuration includes an associated time-offset indication and a reference value, wherein the time-offset indication and the reference value identify a time stamp for a channel prediction, wherein in a case where the time-offset indication indicates an absence of a time-offset value then no prediction is needed and a CSI for the respective CSI report is to be computed using estimates measured on corresponding CSI-reference signal (RS) resources without prediction.

Clause 16. The method of any preceding clause, wherein the one or more CSI reports include at least one of a current CSI report or a predicted future CSI report.

Clause 17. The method of any preceding clause 5, further comprising: applying a prediction mechanism to each serving hypothesis and each interference hypothesis of at-least one sub-configuration to obtain future channel estimates of the one or more channels.

Clause 18. The method of any preceding clause, further comprising: calculating an interference covariance for each interference hypothesis, wherein the interference covariance is scaled based on the power-offset, and wherein each sub-configuration includes an interfering precoder indication or an induced covariance indication; and wherein calculating the interference covariance for each interference hypothesis further comprises calculating the interference covariance for each interference hypothesis based on the interfering precoder indication or the induced covariance indication.

Clause 19. The method of any preceding clause, wherein each sub-configuration includes a vector of time-offsets and/or a vector of frequency offsets, wherein measuring the one or more channels defined by the one or more sub-configurations further comprises measuring the one or more channels defined by the one or more sub-configurations according to a respective vector of time-offset and/or a respective vector of frequency offset, and wherein transmitting the one or more CSI reports for the one or more sub-configurations further comprises transmitting the one or more CSI reports for the one or more sub-configurations in an order based on the vector of time-offsets and/or the vector of frequency offsets.

Clause 20. The method of any preceding clause 6, wherein at least one sub-configuration includes a time-offset indication that is a time interval, wherein measuring the one or more channels defined by the one or more sub-configurations further comprises measuring the one or more channels defined by the least one sub-configuration according to the time-offset indication, and wherein transmitting the one or more CSI reports for the one or more sub-configurations further comprises transmitting the one or more CSI reports for the at least one sub-configurations includes channel state information associated with one or more measurements separated by the time interval.

Clause 21. The method of any preceding clause, wherein at least a portion of the one or more sub-configurations are associated with a fixed codebook type, a fixed precoding matrix indicator, and/or a fixed rank.

Clause 22. The method of any preceding clause, wherein the one or more CSI reports for the one or more sub-configurations include a same set of reporting settings across multiple ones of the one or more sub-configurations.

Clause 23. The method of any preceding clause, wherein a same set of reporting settings across multiple ones of the one or more sub-configurations are configured based on an explicit indicator or based on an implicit indication.

Clause 24. The method of any preceding clause, wherein at least a portion of the one or more sub-configurations define a CSI-resource bandwidth used to measure a CSI-RS resource configured for a neighboring TRP.

Clause 25. The method of any preceding clause, wherein the one or more sub-configurations include a same central processing unit cycle setting and/or a same application processing unit cycle setting.

Clause 26. The method of any preceding clause, wherein the one or more sub-configurations each include one of a plurality of central processing unit resource priority ranks and/or one of a plurality of application processing unit resource priority ranks associated with a corresponding CSI report, and wherein the UE further comprises one or more processing rules configured to prioritize respective CSI reports based on the respective one of the plurality of central processing unit resource priority ranks and/or the respective one of the plurality of application processing unit resource priority ranks.

Clause 27. The method of any preceding clause, wherein respective timelines for transmitting each of the one or more CSI reports depends on a report timing parameter of each sub-configuration, a time-offset indication of each sub-configuration, and/or a UE prediction capability.

Clause 28. The method of any preceding clause, further comprising transmitting a UE prediction capability indication.

Clause 29. The method of clause 28, wherein the UE prediction capability indication includes a cross-frequency sub-band prediction capability and/or a component carrier prediction capability.

Clause 30. The method of any preceding clause, wherein the one or more CSI reports include a per-CSI-RS resource confidence value or a per-tuple confidence value as a function of a time-offset and/or as a function of a frequency offset.

Clause 31. The method of clause 28, wherein the one or more sub-configurations include one or more prediction parameters that are a function of the UE prediction capability indication, and wherein the one or more prediction parameters include a temporal prediction only indicator, a cross-subset with same CSI resource prediction indicator, a cross CSI resource prediction indicator, or any combination thereof.

Clause 32. The method of clause 31, further comprising: generating predicted CSI parameters for a future CSI report for a respective sub-configuration having a respective serving hypothesis and a respective interference hypothesis for the respective subset of ports and the respective power-offset for the one or more CSI-RS resources; measuring test signals corresponding to the respective serving hypothesis and the respective interference hypothesis for the respective subset of ports and the respective power-offset for the one or more CSI-RS resources; generating test CSI parameters based on the measuring of the test signals; determining one or more prediction performance metrics based on a difference between the predicted CSI parameters and the test CSI parameters; and adjusting the one or more prediction parameters based on the one or more prediction performance metrics.

Clause 33. A method of wireless communication, comprising: transmitting a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource; and receiving one or more CSI reports for one or more channels defined by the one or more sub-configurations based on measurements of the one or more channels performed according to the common CSI configuration.

Clause 34. The method of clause 33, wherein a number of the one or more sub-configurations of the one or more channels being measured is less than a total number of the multiple sub-configurations of the common CSI configuration.

Clause 35. The method of any preceding clause, wherein, for each sub-configuration, ports of each respective subset of ports of each CSI-RS resource for each serving hypothesis are different from ports of each respective subset of ports of a same CSI-RS resource for each interference hypothesis.

Clause 36. The method of any preceding clause, wherein each serving hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

Clause 37. The method of any preceding clause, wherein each interference hypothesis of each sub-configuration is configured to generate a CSI report associated with a respective subset of a plurality of subsets of ports of the one or more CSI-RS resources in a measurement set of the UE, wherein ports of each respective subset of ports of each CSI-RS resource of each serving hypothesis are different from ports of each respective subset of ports of a same CSI-RS resource of each interference hypothesis.

Clause 38. The method of any preceding clause, wherein each CSI report of a respective sub-configuration of the multiple sub-configurations is based on configured parameters of the respective sub-configuration, wherein the configured parameters include one or more of a CSI report type, a rank indicator, wideband and/or sub-band precoding matrix indicator and/or channel quality information, and/or the outside interference indicator.

Clause 39. The method of any preceding clause, wherein each tuple of each sub-configuration is indicated using a variable-length indication.

Clause 40. The method of any preceding clause, further comprising: configuring the UE with a CSI-RS resource for each TRP in a measurement set of TRPs, and a respective interference measurement resource (IMR) or a respective CSI-interference measurement (IM) resource that corresponds to each outside interference indicator.

Clause 41. The method of clause 40, wherein at least one sub-configuration includes a respective serving hypothesis comprising multiple TRPs of one or more TRPs in the measurement set of TRPs.

Clause 42. The method of any preceding clause, wherein at least one sub-configuration includes a same CSI-RS resource of the one or more CSI-RS resources in a respective serving hypothesis and a respective interference hypothesis, with different subsets of ports in the respective serving hypothesis and the respective interference hypothesis.

Clause 43. The method of any preceding clause, wherein the common CSI configuration comprises a plurality of sub-configurations having a same serving hypothesis and a different respective interference hypothesis.

Clause 44. The method of any preceding clause, wherein transmitting the common CSI configuration comprises transmitting a first message; and further comprising: transmitting a second message including an indication of the one or more sub-configurations of the one or more channels to be measured.

Clause 45. The method of any preceding clause, wherein each sub-configuration or each tuple indicates at least one master serving set identifier and at least one a master interference set identifier, wherein each master serving set identifier corresponds with a respective at least one serving hypothesis, and wherein each master interference set identifier corresponds with a respective at least one interference hypothesis.

Clause 46. The method of any preceding clause, wherein the UE is configured to measure the one or more channels using CSI-reference signal (RS) resources and information and parameters of the one or more sub-configurations.

Clause 47. The method of any preceding clause, wherein each sub-configuration includes an associated time-offset indication and a reference value, wherein the time-offset indication and the reference value identify a time stamp for a channel prediction, wherein in a case where the time-offset indication indicates an absence of a time-offset value then no prediction is needed and a CSI for the respective CSI report is to be computed using estimates measured on corresponding CSI-reference signal (RS) resources without prediction.

Clause 48. The method of any preceding clause, wherein the one or more CSI reports include at least one of a current CSI report or a predicted future CSI report.

Clause 49. The method of clause 47, wherein the common CSI configuration indicates to apply a prediction mechanism to each serving hypothesis and each interference hypothesis of at-least one sub-configuration to obtain future channel estimates of the one or more channels.

Clause 50. The method of any preceding clause, wherein the common CSI configuration indicates to calculate an interference covariance for each interference hypothesis, wherein the interference covariance is scaled based on the power-offset, and wherein each sub-configuration includes an interfering precoder indication or an induced covariance indication for calculating the interference covariance for each interference hypothesis.

Clause 51. The method of any preceding clause, wherein each sub-configuration includes a vector of time-offsets and/or a vector of frequency offsets for use in measuring the one or more channels defined by the one or more sub-configurations, and wherein receiving the one or more CSI reports for the one or more sub-configurations further comprises receiving the one or more CSI reports for the one or more sub-configurations in an order based on the vector of time-offsets and/or the vector of frequency offsets.

Clause 52. The method of clause 48, wherein at least one sub-configuration includes a time-offset indication that is a time interval for use in measuring the one or more channels defined by the one or more sub-configurations, and wherein receiving the one or more CSI reports for the one or more sub-configurations further comprises receiving the one or more CSI reports for the at least one sub-configurations includes channel state information associated with one or more measurements separated by the time interval.

Clause 53. The method of any preceding clause, wherein at least a portion of the one or more sub-configurations are associated with a fixed codebook type, a fixed precoding matrix indicator, and/or a fixed rank.

Clause 54. The method of any preceding clause, wherein the one or more CSI reports for the one or more sub-configurations include a same set of reporting settings across multiple ones of the one or more sub-configurations.

Clause 55. The method of any preceding clause, wherein a same set of reporting settings across multiple ones of the one or more sub-configurations are configured based on an explicit indicator or based on an implicit indication.

Clause 56. The method of any preceding clause, wherein at least a portion of the one or more sub-configurations define a CSI-resource bandwidth used to measure a CSI-RS resource configured for a neighboring TRP.

Clause 57. The method of any preceding clause, wherein the one or more sub-configurations include a same central processing unit cycle setting and/or a same application processing unit cycle setting.

Clause 58. The method of any preceding clause, wherein the one or more sub-configurations each include one of a plurality of central processing unit resource priority ranks and/or one of a plurality of application processing unit resource priority ranks associated with a corresponding CSI report, and wherein the one or more sub-configurations each include one or more processing rules configured to prioritize respective CSI reports based on the respective one of the plurality of central processing unit resource priority ranks and/or the respective one of the plurality of application processing unit resource priority ranks.

Clause 59. The method of any preceding clause, wherein respective timelines for the UE to transmit each of the one or more CSI reports depends on a report timing parameter of each sub-configuration, a time-offset indication of each sub-configuration, and/or a UE prediction capability.

Clause 60. The method of any preceding clause, further comprising receiving a UE prediction capability indication.

Clause 61. The method of clause 60, wherein the UE prediction capability indication includes a cross-frequency sub-band prediction capability and/or a component carrier prediction capability.

Clause 62. The method of any preceding clause, wherein the one or more CSI reports include a per-CSI-RS resource confidence value or a per-tuple confidence value as a function of a time-offset and/or as a function of a frequency offset.

Clause 63. The method of clause 60, wherein the one or more sub-configurations include one or more prediction parameters that are a function of the UE prediction capability indication, and wherein the one or more prediction parameters include a temporal prediction only indicator, a cross-subset with same CSI resource prediction indicator, a cross CSI resource prediction indicator, or any combination thereof.

Clause 64. The method of clause 63, further comprising: transmitting one or more test signals for generating predicted CSI parameters for a future CSI report for a respective sub-configuration having a respective serving hypothesis and a respective interference hypothesis for the respective subset of ports and the respective power-offset for the one or more CSI-RS resources corresponding to the respective serving hypothesis and the respective interference hypothesis; and receiving prediction performance information based on the one or more test signals.

Clause 65. An apparatus for wireless communication comprising one or more memories, and one or more processors coupled with one or more memories and configured, individually or in combination, to perform the method of any of clauses 1-32 and/or any of clauses 33-64.

Clause 66. An apparatus for wireless communication comprising one or more means for performing the method of any of clauses 1-32 and/or any of clauses 33-64.

Clause 67. A computer-readable medium comprising stored instructions for wireless communication, wherein the instructions are executable by one or more processors, individually or in combination, to perform the method of any of clauses 1-32 and/or any of clauses 33-64.

The description herein is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth^{®}standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G, 5G, 6G, or further implementations thereof, technology.

Further, several aspects of telecommunication systems has been presented with reference to various apparatus and methods. These apparatus and methods may be described in this detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software, or a combination thereof, depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Similarly, in one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a non-transitory computer readable and/or storage media for execution by, or to control the operation of, a data processing apparatus. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, a phrase referring to “at least one of” a list of items refers to any combination of those items, including single members. As an example, “at least one of: a, b, or c” is intended to cover: a, b, c, a-b, a-c, b-c, and a-b-c.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

Thus, based on the foregoing, various modifications to the implementations described in this disclosure may be readily apparent to those skilled in the art, and the generic principles defined herein may be applied to other implementations without departing from the spirit or scope of this disclosure. Thus, the following claims are not intended to be limited to the implementations shown herein, but are to be accorded the widest scope consistent with this disclosure, and the principles and the novel features described herein.

What is claimed is:

1. An apparatus for wireless communication, comprising:
one or more memories; and
one or more processors coupled with one or more memories and configured,, individually or in combination, to:
measure one or more channels defined by one or more sub-configurations of a common channel state information (CSI) configuration for a user equipment (UE), wherein the common CSI configuration includes multiple sub-configurations, wherein each sub-configuration includes a tuple that indicates at least one serving hypothesis and at least one interference hypothesis or an outside interference indicator, wherein each serving hypothesis and each interference hypothesis comprises a respective subset of ports and a power-offset from a respective CSI-RS resource; and
transmit one or more CSI reports for the one or more sub-configurations based on the measuring of the one or more channels performed according to the common CSI configuration.

2. The apparatus of claim 1, wherein a number of the one or more sub-configurations of the one or more channels being measured is less than a total number of the multiple sub-configurations of the common CSI configuration.

3. The apparatus of claim 1, wherein, for each sub-configuration, ports of each respective subset of ports of each CSI-RS resource for each serving hypothesis are different from ports of each respective subset of ports of a same CSI-RS resource for each interference hypothesis.

4. The apparatus of claim 1, wherein each CSI report of a respective sub-configuration of the multiple sub-configurations is based on configured parameters of the respective sub-configuration, wherein the configured parameters include one or more of a CSI report type, a rank indicator, wideband and/or sub-band precoding matrix indicator and/or channel quality information, and/or the outside interference indicator.

5. The apparatus of claim 1, wherein the UE is configured with a CSI-RS resource for each TRP in a measurement set of TRPs, and a respective interference measurement resource (IMR) or a respective CSI-interference measurement (IM) resource that corresponds to each outside interference indicator.

6. The apparatus of claim 1, wherein the common CSI configuration comprises a plurality of sub-configurations having a same serving hypothesis and a different respective interference hypothesis.

7. The apparatus of claim 1, wherein the one or more processors are further configured to:
receive a first message including the common CSI configuration; and
receive a second message including an indication of the one or more sub-configurations of the one or more channels to be measured.

8. The apparatus of claim 1, wherein to measure the one or more channels comprises using CSI-reference signal (RS) resources and information and parameters of the one or more sub-configurations.

9. The apparatus of claim 1, wherein each sub-configuration includes an associated time-offset indication and a reference value, wherein the time-offset indication and the reference value identify a time stamp for a channel prediction, wherein in a case where the time-offset indication indicates an absence of a time-offset value then no prediction is needed and a CSI for the respective CSI report is to be computed using estimates measured on corresponding CSI-reference signal (RS) resources without prediction.

10. The apparatus of claim 9, wherein the one or more processors are further configured to:
apply a prediction mechanism to each serving hypothesis and each interference hypothesis of at-least one sub-configuration to obtain future channel estimates of the one or more channels.

11. The apparatus of claim 1, wherein the one or more processors are further configured to:
calculate an interference covariance for each interference hypothesis, wherein the interference covariance is scaled based on the power-offset, and wherein each sub-configuration includes an interfering precoder indication or an induced covariance indication; and
wherein to calculate the interference covariance for each interference hypothesis the one or more processors are further configured to calculate the interference covariance for each interference hypothesis based on the interfering precoder indication or the induced covariance indication.

12. The apparatus of claim 1, wherein each sub-configuration includes a vector of time-offsets and/or a vector of frequency offsets, wherein to measure the one or more channels defined by the one or more sub-configurations the one or more processors are further configured to measure the one or more channels defined by the one or more sub-configurations according to a respective vector of time-offset and/or a respective vector of frequency offset, and wherein to transmit the one or more CSI reports for the one or more sub-configurations the one or more processors are further configured to transmit the one or more CSI reports for the one or more sub-configurations in an order based on the vector of time-offsets and/or the vector of frequency offsets.

13. The apparatus of claim 1, wherein the one or more CSI reports for the one or more sub-configurations include a same set of reporting settings across multiple ones of the one or more sub-configurations.

14. The apparatus of claim 1, wherein a same set of reporting settings across multiple ones of the one or more sub-configurations are configured based on an explicit indicator or based on an implicit indication.

15. The apparatus of claim 1, wherein the one or more sub-configurations each include one of a plurality of central processing unit resource priority ranks and/or one of a plurality of application processing unit resource priority ranks associated with a corresponding CSI report, and wherein the UE further comprises one or more processing rules configured to prioritize respective CSI reports based on the respective one of the plurality of central processing unit resource priority ranks and/or the respective one of the plurality of application processing unit resource priority ranks.

16. The apparatus of claim 1, wherein respective timelines for transmitting each of the one or more CSI reports depends on a report timing parameter of each sub-configuration, a time-offset indication of each sub-configuration, and/or a UE prediction capability.

17. The apparatus of claim 1, wherein the one or more processors are further configured to transmit a UE prediction capability indication.

18. The apparatus of claim 17, wherein the UE prediction capability indication includes a cross-frequency sub-band prediction capability and/or a component carrier prediction capability.

19. The apparatus of claim 17, wherein the one or more sub-configurations include one or more prediction parameters that are a function of the UE prediction capability indication, and wherein the one or more prediction parameters include a temporal prediction only indicator, a cross-subset with same CSI resource prediction indicator, a cross CSI resource prediction indicator, or any combination thereof.

20. The apparatus of claim 19, wherein the one or more processors are further configured to:
generate predicted CSI parameters for a future CSI report for a respective sub-configuration having a respective serving hypothesis and a respective interference hypothesis for the respective subset of ports and the respective power-offset for the one or more CSI-RS resources;
measure test signals corresponding to the respective serving hypothesis and the respective interference hypothesis for the respective subset of ports and the respective power-offset for the one or more CSI-RS resources;
generate test CSI parameters based on the measuring of the test signals;
determine one or more prediction performance metrics based on a difference between the predicted CSI parameters and the test CSI parameters; and
adjust the one or more prediction parameters based on the one or more prediction performance metrics.
